(19) United States
(12) Patent Application Publication
(10) Pub. No.: US 2026/0333117 A1
(43) Pub. Date: Oct. 22, 2026

(54) METHOD AND APPARATUS FOR NOTIFYING QoS CHANGE, DEVICE AND MEDIUM

(71) Applicant: TENCENT TECHNOLOGY (SHENZHEN) COMPANY LIMITED, Shenzhen (CN)

(72) Inventor: Chunshan XIONG, Shenzhen (CN)

(73) Assignee: TENCENT TECHNOLOGY (SHENZHEN) COMPANY LIMITED, Shenzhen (CN)

(21) Appl. No.: 19/717,633

(22) Filed: Jun. 23, 2026

Related U.S. Application Data
(63) Continuation of application No. 17/986,795, filed on Nov. 14, 2022.
Application No. 17/986,795 is a continuation of application No. PCT/CN2022/070541, filed on Jan. 6, 2022.

(30) Foreign Application Priority Data
Feb. 25, 2021 (CN) 202110214402.1

(51) Int. Cl. H04W 28/02; H04L 41/5003

(52) U.S. Cl. CPC H04W 28/0268; H04L 41/5003

(57) ABSTRACT

In a method for notifying a quality of service (QoS) change, a notification message is transmitted, by an access network device, to an application entity when a change of a parameter of a quality of service notification control (QNC) of a non-guaranteed bit rate (non-GBR) bearing flow in a mobile network meets a reporting condition. The application entity is configured to perform an application function (AF) through a core network entity. An updated reporting condition of the QNC is received by the access network device. The updated reporting condition is determined and transmitted by the application entity to the access network device through the core network entity when the application entity determines that a reporting frequency of the notification message is greater or less than a frequency threshold. The reporting frequency of the notification message is updated by the access network device based on the updated reporting condition.

### RELATED APPLICATIONS

The present application is a continuation of U.S. application Ser. No. 17/986,795 filed on Nov. 14, 2022, which is a continuation of International Application No. PCT/CN2022/070541, entitled “NOTIFICATION METHOD AND APPARATUS FOR QoS CHANGES, DEVICE AND MEDIUM” and filed on Jan. 6, 2022, which claims priority to Chinese Patent Application No. 202110214402.1, entitled “METHOD AND APPARATUS FOR NOTIFYING QoS CHANGE, DEVICE AND MEDIUM” and filed on Feb. 25, 2021. The entire disclosures of the prior applications are hereby incorporated by reference.

### FIELD OF THE TECHNOLOGY

Embodiments of this application relate to the field of mobile communication, including a method and apparatus for notifying a quality of service (QoS) change, a device and a medium.

### BACKGROUND OF THE DISCLOSURE

In a 5th-generation (5G) mobile communication technology, QoS control is performed in units of QoS flows.

According to the bearing type, the QoS flows are divided into a guaranteed bit rate (GBR) and a non-guaranteed bit rate (non-GBR). For the QoS flow of the GBR, when network resources are tight, a corresponding bit rate may also be guaranteed; and for the QoS flow of the non-GBR, in the case that the network resources are tight, a requirement of reducing the rate needs to be borne.

At present, more than 90% of service flow is the non-GBR QoS flow, such as common audio and video calls and online conferences. Because the change of a wireless network state often causes a jam in audio and video communication, it is necessary to optimize the QoS control of the non-GBR QoS flow.

### SUMMARY

This disclosure provides a method and apparatus for notifying a QoS change, a device and a medium, and provides a QNC mechanism for a non-GBR QoS flow, which can enable an application entity to perceive changes in a wireless network state. In an embodiment, a method for notifying a QoS change includes determining that a change of a parameter of QoS notification control (QNC) of a non-guaranteed bit rate (non-GBR) bearing flow in a mobile network meets a reporting condition. The method further includes, in response to the determination that the change of the parameter of the QNC meets the reporting condition, transmitting a notification message to an application entity by an access network device through a core network entity.

In an embodiment, an apparatus for notifying a QoS change includes processing circuitry configured to determine that a change of a parameter of QoS notification control (QNC) of a non-guaranteed bit rate (non-GBR) bearing flow in a mobile network meets a reporting condition. The processing circuitry is further configured to transmit a notification message to an application entity through a core network entity.

In an embodiment, a non-transitory computer-readable storage medium stores computer-readable instructions thereon, which, when executed by a processing device, cause the processing device to perform a method for notifying a QoS change. The method includes determining that a change of a parameter of QoS notification control (QNC) of a non-guaranteed bit rate (non-GBR) bearing flow in a mobile network meets a reporting condition. The method further includes, in response to the determination that the change of the parameter of the QNC meets the reporting condition, transmitting a notification message to an application entity by an access network device through a core network entity.

When increase/decrease of the parameter of the QNC of the non-GBR bearing flow satisfies the reporting condition, the notification message is transmitted to the application entity through the core network entity, so that the QNC mechanism is provided for the non-GBR bearing flow, and the application entity can know the changes of the wireless network state of the non-GBR bearing flow.

### BRIEF DESCRIPTION OF THE DRAWINGS

FIG. 1 illustrates a structural block diagram of a mobile communication system provided by an exemplary embodiment of this disclosure.

FIG. 2 illustrates a structural block diagram of a communication system provided by another exemplary embodiment of this disclosure.

FIG. 3 illustrates a flowchart of a method for notifying a QoS change provided by an exemplary embodiment of this disclosure.

FIG. 4 illustrates a flowchart of a method for notifying a QoS flow provided by another exemplary embodiment of this disclosure.

FIG. 5 illustrates a flowchart of a configuration method of QNC provided by an exemplary embodiment of this disclosure.

FIG. 6 illustrates a flowchart of a configuration method of QNC provided by another exemplary embodiment of this disclosure.

FIG. 7 illustrates a flowchart of a configuration method of QNC provided by another exemplary embodiment of this disclosure.

FIG. 8 illustrates a flowchart of an optimization method of QNC provided by an exemplary embodiment of this disclosure.

FIG. 9 illustrates a flowchart of an optimization method of QNC provided by another exemplary embodiment of this disclosure.

FIG. 10 illustrates a flowchart of a method for notifying a parameter value of QNC provided by an exemplary embodiment of this disclosure.

FIG. 11 illustrates a flowchart of a method for notifying a QoS change in a handover process provided by an exemplary embodiment of this disclosure.

FIG. 12 illustrates a flowchart of a method for notifying a QoS change in a handover process provided by another exemplary embodiment of this disclosure.

FIG. 13 illustrates a flowchart of a method for notifying a QoS change in a handover process provided by another exemplary embodiment of this disclosure.

FIG. 14 illustrates a schematic diagram of a PDU session modification (for non-roaming and local breakout roaming) process requested by UE or a network provided by an exemplary embodiment of this disclosure.

FIG. 15 illustrates a schematic diagram of an SM strategy association modification process provided by an exemplary embodiment of this disclosure.

FIG. 16 illustrates a schematic diagram of an Xn-based inter NG-RAN handover process without UPF reallocation provided by an exemplary embodiment of this disclosure.

FIG. 17 illustrates a schematic diagram of a message structure of an N2 path handover request provided by an exemplary embodiment of this disclosure.

FIG. 18 illustrates a schematic diagram of an N2 handover process based on an NG-RAN node provided by an exemplary embodiment of this disclosure.

FIG. 19 illustrates a schematic diagram of a PDU session establishment process requested by UE provided by an exemplary embodiment of this disclosure.

FIG. 20 illustrates a flowchart of a PDU session establishment process requested by UE in a home route roaming scenario provided by an exemplary embodiment of this disclosure.

FIG. 21 illustrates a schematic diagram of a process of transferring an AF request for a single UE address to a related PCF provided by an exemplary embodiment of this disclosure.

FIG. 22 illustrates a schematic diagram of a PDU session modification process requested by UE or a network for non roaming and local breakout roaming provided by an exemplary embodiment of this disclosure.

FIG. 23 illustrates a schematic diagram of a PDU session modification process requested by UE or a network for home route roaming provided by an exemplary embodiment of this disclosure.

FIG. 24 illustrates a schematic diagram of a handover program in a base station provided by an exemplary embodiment of this disclosure.

FIG. 25 illustrates a schematic diagram of an Xn-based inter NG-RAN handover process without UPF reallocation provided by another exemplary embodiment of this disclosure.

FIG. 26 illustrates a message structural diagram of a handover request provided by an exemplary embodiment of this disclosure.

FIG. 27 illustrates a schematic diagram of a handover process based on XG-RAN node N2 provided by an exemplary embodiment of this disclosure.

FIG. 28 illustrates a message structural diagram of a handover request provided by an exemplary embodiment of this disclosure.

FIG. 29 illustrates a message structural diagram of a handover request provided by an exemplary embodiment of this disclosure.

FIG. 30 illustrates a schematic diagram of a handover process (non roaming and local breakout roaming) of a PDU session process accessed from an untrusted non-3GPP to a 3GPP provided by an exemplary embodiment of this disclosure.

FIG. 31 illustrates a schematic handover diagram of handing over from EPC/ePDG to 5GS provided by an exemplary embodiment of this disclosure.

FIG. 32 illustrates a schematic diagram of a preparation stage of interworking based on single registration from evolved packet system (EPS) to 5GS provided by an exemplary embodiment of this disclosure.

FIG. 33 illustrates a block diagram of an apparatus for notifying a QoS change provided by an exemplary embodiment of this disclosure.

FIG. 34 illustrates a block diagram of a network cell device provided by an exemplary embodiment of this disclosure.

### DESCRIPTION OF EMBODIMENTS

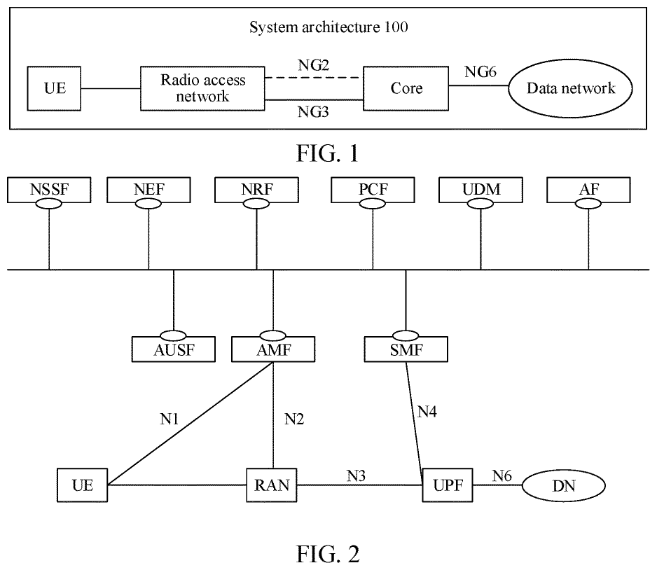

FIG. 1 illustrates a schematic architectural diagram of a mobile communication system provided by an exemplary embodiment of this disclosure. As shown in FIG. 1, a system architecture 100 may include: a user equipment (UE), a radio access network (RAN), a Core and a data network (DN). The UE, the RAN and the Core are the main components of the architecture. Logically, they can be divided into a user plane and a control plane, the control plane is responsible for the management of a mobile network, and the user plane is responsible for the transmission of service data. In FIG. 1, a reference point NG2 is located between a RAN control plane and a Core control plane, a reference point NG3 is located between a RAN user plane and a Core user plane, and a reference point NG6 is located between a Core user plane and the data network.

UE: it is an entrance for mobile users to interact with the network. It can provide basic computing capabilities and storage capabilities, display service windows to the users, and accept user operation input. The UE may use a next-generation air interface technology to establish a signal connection and a data connection with the RAN, so that control signals and service data are transmitted to the mobile network.

RAN: similar to a base station in a traditional network, it is deployed close to the UE to provide network access functions for authorized users within a cell coverage range, and can use transmission tunnels of different quality to transmit user data according to user levels and service requirements. The RAN can manage its own resources, utilize them properly, provide access services for the UE as required, and forward the control signals and the user data between the UE and the Core.

Core: it is responsible for maintaining subscription data of the mobile network, manage network cells of the mobile network, and provide session management, mobility management, strategic management, security authentication and other functions for the UE. Network access authentication is provided for the UE when the UE is attached. Network resources are allocated to the UE when the UE has a service request. The network resources are updated for the UE when the UE moves. A fast recovery mechanism is provided for the UE when the UE is idle. The network resources are released for the UE when the UE is de-attached. A data routing function is provided for the UE when the UE has service data, for example, uplink data are forwarded to a DN. Or, downlink data of the UE are received from the DN and then forwarded to the RAN, so as to be transmitted to the UE.

DN: It is a data network for providing business services for users. Generally, a client is located in the UE, and a server is located in the data network. The data network may be a private network, such as a local area network, an external network not controlled by operators, such as Internet, or a proprietary network jointly deployed by the operators, such as to configure IP multimedia core network subsystem (IMS) services.

FIG. 2 is a detailed architecture determined on FIG. 1, and the Core user plane includes a user plane function (UPF). The Core control plane includes an authentication server function (AUSF), an access and mobility management function (AMF), a session management function (SMF), a network slice selection function (NSSF), a network exposure function (NEF), an NF repository function (NEF), a unified data management (UDM), a policy control function (PCF), and an application function (AF). The functions of these functional entities are as follows:
UPF: perform user data packet forwarding according to routing rules of the SMF;
AUSF: perform security authentication of the UE;
AMF: UE access and mobility management;
SMF: UE session management;
NSSF: select network slice for the UE;
NEF: open network functions to third parties in the form of an interface API;
NRF: provide a storage function and a selection function of network function entity information for other network cells;
UDM: user subscription context management;
PCF: user policy management; and
AF: user application management.

In the architecture shown in FIG. 2, an interface N1 is a reference point between the UE and the AMF; an interface N2 is a reference point of the RAN and the AMF, and used for transmission of NAS messages and the like; an interface N3 is a reference point between the RAN and the UPF, and used for transmitting data of the user plane and the like; an interface N4 is a reference point between the SMF and the UPF, and used for transmitting information such as tunnel identification information and data cache indication information connected by the N3, and a downlink data notification message; and an interface N6 is a reference point between the UPF and the DN, and used for transmitting data of the user plane. Interface NG: an interface between the radio access network and a 5G Core.

It needs to be illustrated that, the interface name between each network cell in FIG. 1 and FIG. 2 is just an example, and the interface name in a specific implementation may be other names, which is not specifically limited in this embodiment of this disclosure. The name of each network cell (such as SMF, AF, UPF, etc.) included in FIG. 1 and FIG. 2 is also only an example, and the function of the network cell itself is not limited. In 5GS and other future networks, the above network cells may also have other names, which is not specifically limited in this embodiment of this disclosure. For example, in a 6G network, some or all of the above network cells may use the terms in 5G, and may also use other names, etc., which is uniformly described here, and will not be repeated below. In addition, it is to be understood that the names of messages (or signaling) transmitted between the above network cells are only an example, and do not constitute any limitation on the functions of the messages themselves.

In this embodiment of this disclosure, a quick change QoS notification control (QCQNC) mechanism is defined for a non-GBR QoS flow. The QCQNC mechanism is one of QoS notification control (QNC). In the QCQNC mechanism provided by this embodiment of this disclosure, the access network, in response to detecting that at least one QoS parameter of the non-GBR QoS flow changes quickly, transmits a quick change notification to the SMF. The SMF transmits the quick change notification to the PCF, the AF and the UE. After receiving the quick change notification, the AF and the UE adjust their internal applications, so that the applications can adapt to the changes, so as to prevent jamming and other phenomena affecting the quality of experience (QoE).

The QoS flow is a smallest QoS differentiation granularity in a PUD session. In a 5G system, a QoS flow identifier (QFI) is used for distinguishing the QoS flow. The QoS flow is controlled by the SMF, and can be preconfigured, established in the PDU session establishment process, or modified in the PDU session modification process.

In this embodiment of this disclosure, the following QoS profiles are defined for the non-GBR QoS flow: 5G QoS identifier (5QI), allocation and retention priority (ARP) and reflective QoS attribute (RQA).

Corresponding to the 5QI of the non-GBR QoS flow, only the following QoS profiles are defined:
a resource type;
divided into: GBR, delay critical GBR or non-GBR.
A priority level;
A packet delay budget (PDB); and
a packet data delay (budget), including the packet delay of the Core.
A packet error rate.

Among the four QoS profiles, the first two parameters, the resource type and priority, define the profiles of the 5QI, while the second two parameters, PDB and PER, define the performance of the 5QI.

In this embodiment of this disclosure, it is proposed that the profile of the QoS QNC is three parameters PDB, PER and a current bit rate (CBR) related to the non-GBR QoS flow (NGBF). When the RAN detects that any one of the three parameters increases or decreases by a change rate (or, increases decreases by a change value) beyond a change threshold (because different parameters have different properties, their corresponding change rates or change values are different for each parameter), a notification message is transmitted to the SMF, and the parameter values or change rates or change values of all parameter changes are notified. The SMF transmits the notification message to the PCF, the PCF transmits the notification message to the AF, and the application program corresponding to the AF makes corresponding adjustment. At the same time, the SMF transmits the notification message through an NAS message, the application program corresponding to the UE can also make corresponding adjustment, so as to realize the interaction between the network and the application, optimize the service transmission, and solve the jamming when the network is congested; or after network conditions become better, the application program still uses a very low transmission rate, as a result, the network resources cannot be fully utilized, and the user experience cannot be improved.

In one embodiment, there are two definitions of parameter change:
1. Change value;
when the parameter value is changed from A to B, B-A is defined as the change value. It is assumed that a change value of the parameter value changed from A to B is a first change value, and a change value changed from B back to A is a second change value, amplitudes of the first change value and the second change value are the same (regardless of positive and negative).
2. Change rate.

In a possible design, when the parameter value is changed from A to B, (B-A)/A is defined as the change rate. It is assumed that a change rate of the parameter value changed from A to B is a first change rate (B-A)/A, and a change rate changed from B back to A is a second change rate (A-B)/B, amplitudes of the first change rate and the second change rate are the same (regardless of positive and negative).

That is, the amplitude of (B−A)/A is not equal to (A−B)/B (assuming B>A>0). Therefore, in the above definition, after the parameter value A increases by 30% to the parameter value B, the parameter value B decreases by 30%, and it does not return to the parameter value A.

In another possible design, in order to make the same parameter value increase by 30% and then decrease by 30%, which means to return to the same parameter value, the change rate is uniformly defined as the (larger value-smaller value)/smaller value before and after the parameter value changes, or the change rate is uniformly defined as the (larger value-smaller value)/larger value before and after the parameter value changes, or the change rate is uniformly defined as the (larger value-smaller value)/a fixed value before and after the parameter value changes. The larger value is a larger absolute value of the parameter values before and after the change, the smaller value is a smaller absolute value of the parameter values before and after the change, and the fixed value is a value that is determined in advance and remains unchanged. In this way, when the parameter value A first increases by 30% and then decreases by 30%, it will return to the original parameter value A.

In one embodiment, the following communication protocol is provided:

### QoS Profile

Whether one QoS flow is GBR or non-GBR is determined by its QoS profile. The QoS profile of the QoS flow is transmitted to the (R)AN, including the following QoS parameters (detailed information of the QoS parameters is defined in section 5.7.2 of a communication protocol TS23.501).
For each QoS flow, the QoS parameters to be included in the QoS profile:
   5QI; and
   ARP;
   Only for each non-GBR QoS flow, the QoS profile may further include the following QoS parameters:
   QCQNC;
RQA;
Only for the QoS flow of each GBR, the QoS profile may further include the following QoS parameters:
a guaranteed flow bit rate (GFBR)-uplink and downlink, and
a maximum flow bit rate (MFBR)-uplink and downlink; and
   only for the GBR QoS flow, the QoS profile may further include one or more QoS parameters;
   notification control;
   a maximum packet loss rate-uplink and downlink.

In one embodiment, a QoS quick change notification control profile is provided.

The QoS quick change notification control profile is provided for the non-GBR QoS flow that enables the quick change notification control. If the corresponding PCC rules contain relevant information (as described in the communication protocol TS23.503), the SMF shall provide the NG-RAN with the quick change notification control profile in addition to the QoS profile file. If the SMF provides the NG-RAN with the quick change notification control profile (if the corresponding policy control and charging (PCC) rule information changes), the NG-RAN will replace the previously stored profile with it.

The quick change notification control profile represents the quick change of any QoS parameter PDB, PER and a detected CBR (current bit rate), which will help the application program control the application program flow according to the changed QoS parameters. The quick change notification control profile represents that (PDR, PER AND CBR) changes (increases or decreases) quickly by (20%, 10% and 30%) in a short time, and a changed new value can be maintained continuously, that is, this quick change is not a short and quick thorn peak caused by sudden impact interference and other reasons.

Note: the quick change notification control profile may be any change combination of the PDB, the PER and the CBR, for example, the quick change notification control profile may set the increased (or decreased) PDR to 20%; or set the increased (or decreased) PDR and PER to 20%, and the increased (or decreased) CBR to 10%; or set the increased (or decreased) CBR to 30%.

When the NG-RAN transmits a quick change notification that satisfies a QCQNC profile to the SMF, the NG-RAN shall further include the current QoS parameters (PDB and PER) and CBR in the notification message.

The QNC mechanism of the non-GBR bearing flow at least includes the following processes:
a notification process of the QNC (for the AF);
a configuration process of the QNC;
an optimization process of the QNC;
a notification process of the parameter value of the QNC (for the UE); and
QNC control in a handover process.

The above processes are described below.

### 1. The Notification Process of the QNC (for the AF):

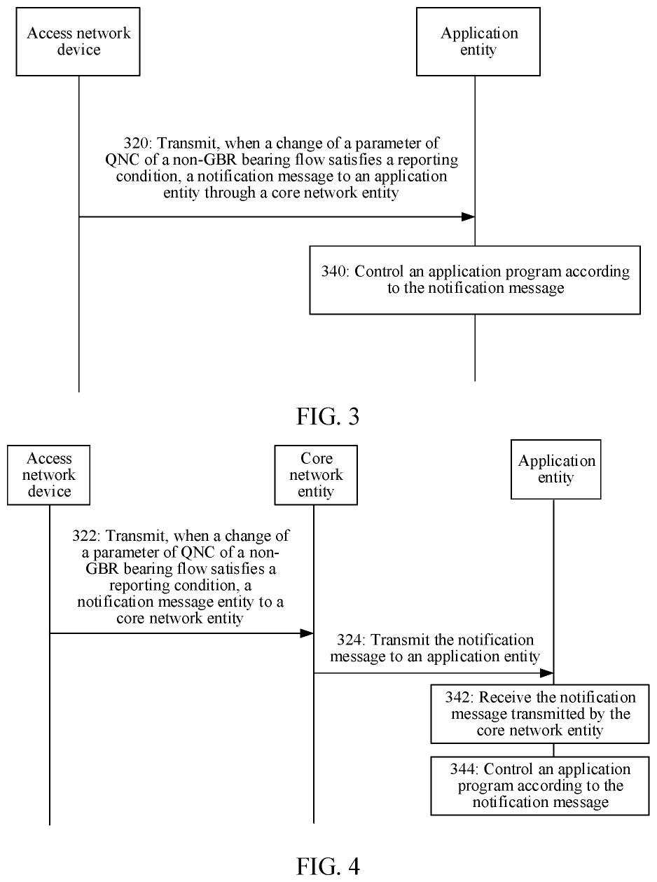

FIG. 3 is a flowchart of a method for notifying a QoS change provided by an exemplary embodiment of this disclosure. This embodiment is described by using an example in which the method is applied to the mobile communication system shown in FIG. 1 or FIG. 2. The method includes:
Step 320: transmit, when a change of a parameter of QNC of a non-GBR bearing flow satisfies a reporting condition, a notification message to an application entity by an access network device through a core network entity. For example, it is determined that a change of a parameter of QoS notification control (QNC) of a non-guaranteed bit rate (non-GBR) bearing flow in a mobile network meets a reporting condition and a notification message is transmitted to an application entity through a core network entity.

The non-GBR bearing flow refers to a bearing flow of a non-GBR type. The non-GBR bearing flow includes: a non-GBR QoS flow, or a non-GBR EPS bearer. Exemplarily, in a 5G system, the non-GBR bearing flow is the QoS flow of the non-GBR type; and in a 4G system, the non-GBR bearing flow is an EPS bearer of the non-GBR type.

Exemplarily, the parameter of the QNC (or QCQNC) includes at least one of the following: PDB, PER and CBR. When the parameter of the QNC includes at least two kinds, at least two reporting conditions corresponding to the parameter are the same; and/or at least two reporting conditions corresponding to the parameter are different.

Exemplarily, the reporting condition (or change threshold and change report threshold) includes at least one of the following:
a change value of the parameter of the QNC within a first duration is greater than a first threshold; and
the first threshold is a decimal greater than 0 and less than 1. For example, the first threshold is 20%, 30% and 40%. The first duration is a period or duration for calculating the change value, such as 1 second and 2 seconds.

A change rate of the parameter of the QNC within a second duration is greater than a second threshold; and
the second threshold is a decimal greater than 0 and less than 1. For example, the second threshold is 20%, 30% and 40%. The second duration is a period or duration for calculating the change rate, such as 1 second and 2 seconds.

The change value of the parameter of the QNC within the first duration is greater than the first threshold, and a third threshold (or third time duration) is continuously maintained at the changed value; and
the third threshold is threshold for measuring a maintained duration of the change value, such as 2 seconds.

The change rate of the parameter of the QNC within the second duration is greater than the second threshold, and a fourth threshold (or fourth time duration) is continuously maintained at the change rate.

The fourth threshold is a threshold for measuring a maintained duration of the change rate, such as 2 seconds.

That is, the third threshold and the fourth threshold are the thresholds for measuring the duration.

Exemplarily, the notification message further carries: a value of the changed parameter of the QNC. That is, the parameter value is a current parameter value of the parameter of the QNC after the parameter of the QNC quickly changes. The “current” is a relative concept, not an absolute current. For example, the current parameter value is a parameter value when the reporting condition is triggered, which is not necessarily equal to the real-time parameter value after transmitting the notification message.

Exemplarily, the parameter value of the changed QNC may be represented using a quantized value of the parameter value of the changed QNC. For example, a value range of the QNC is divided into 16 non-overlapping subintervals. Each of the 16 subintervals corresponds to a unique quantized value, which is represented by four bits. When the parameter value of the changed QNC belongs to an i^{th} subinterval, the quantized value corresponding to the i^{th} subinterval is used for representing, and the quantized value only needs 4 bits, which can reduce transmission resources required for the notification message.
Step 340: The application entity controls an application program according to the notification message.

The notification message (or quick change notification, quick change report, and notification report) is used for indicating that the change of the parameter of the QNC of the non-GBR bearing flow satisfies the reporting condition.

The application entity controls at least one of a calculation strategy and a flow strategy of the application program according to the notification message, so as to make the application program adapt to the quick change of related parameters of the non-GBR bearing flow.

There are one or more application programs running on the application entity, and the same application program corresponds to at least one service data flow (SDF). The SDF with different QoS requirements may be mapped to independent QoS flow respectively, for example, the SDF with a first QoS requirement may be mapped to a first QoS flow, and the SDF with a second QoS requirement may be mapped to a second QoS flow. The SDF with the same QoS requirements may be mapped to the same QoS flow.

In this embodiment of this disclosure, it is assumed that one or more QoS flows corresponding to one application program include a non-GBR QoS flow, and the non-GBR QoS flow is used for transmitting data packets of at least one of voice, video, text, message, file, control information and other services.

To sum up, according to the method provided by the embodiment, when increase/decrease of the parameter of the QNC of the non-GBR bearing flow satisfies the reporting condition, the notification message is transmitted to the application entity through the core network entity, so that the QNC mechanism is provided for the non-GBR bearing flow, and the application entity can know the changes of the wireless network state of the non-GBR bearing flow.

The steps performed by the access network device may be separately implemented as one embodiment on the access network device side; and the steps performed by the application entity may be separately implemented as one embodiment on the application entity side, and will not be repeated in this disclosure.

FIG. 4 is a flowchart of a method for notifying a QoS change provided in another exemplary embodiment of this disclosure. This embodiment is described by using an example in which the method is applied to the communication system shown in FIG. 1 or FIG. 2. The method includes:
Step 322: transmit, when a change of a parameter of QNC of a non-GBR bearing flow satisfies a reporting condition, a notification message entity to a core network entity by an access network device; and
receive, by the core network entity, a notification message transmitted by the access network device. The notification message is used for indicating that the change of the parameter of QoS notification control QNC of the non-GBR bearing flow satisfies the reporting condition.
Step 324: transmit a notification message to an application entity by a core network entity; and
there are one or more core network entities. when the notification message involves a plurality of core network entities located between the RAN and the AF, the plurality of core network entities transmit the notification message in sequence, and different core network entities may adopt different types of messages to carry the notification message. For example, the core network entity includes: a mobility management entity (MME), a serving gateway (SGW), a PDN gateway (PGW) and a PCF, and a transmission path of the notification message at least includes: RAN→MME→SGW/PGW→PCF→AF; and In another example, the core network entity includes: a first core network entity AMF, a second core network entity SMF and a third core network entity PCF, and the transmission path of the notification message at least includes RAN→AMF→SMF→PCF→AF.

Exemplarily, event reporting is transmitted by the core network entity to the application entity, and the event reporting carries the notification message.
Step 342: receive, by the core network entity, the notification message transmitted by the core network entity.

Exemplarily, the application entity receives the event reporting transmitted by the core network entity.
Step 344: The application entity controls an application program according to the notification message.

The application entity controls at least one of a calculation strategy and a flow strategy of the application program according to the notification message, so as to make the application program adapt to the quick change of related parameters of the non-GBR bearing flow. Therefore, QoE of users is guaranteed as much as possible, and the phenomenon such as jamming is avoided.

Taking an application program on a server side of an online session as an example, the application program corresponds to 4 SDFs: a voice SDF, a video SDF, a text message SDF and a control plane SDF. The 4 SDFs correspond to 4 non-GBR QoS flows, and QNC mechanisms are enabled for the 4 non-GBR QoS flows respectively.

A first possible implementation:

In response to the notification message being used for indicating that the parameter value of the QNC becomes worse, the application program is controlled to be performed according to a first calculation strategy.

In response to the notification message being used for indicating that the parameter value of the QNC becomes better, the application program is controlled to be performed according to a second calculation strategy.

A calculation duration of the same calculation task under the first calculation strategy is shorter than a calculation duration under the second calculation strategy.

The calculation strategy is a strategy related to the running calculation of the application program. The calculation strategy includes, but is not limited to: at least one of a selection strategy of an encoding and decoding mode, a selection strategy of an encoding and decoding model, a selection strategy of an encoding and decoding level, a selection strategy of a compression level and a selection strategy of a neural network model.

Taking the calculation strategy including the selection of an encoding and decoding mode as an example, in response to the notification message being used for indicating the parameter value of the QNC becomes worse, the application program is controlled to adopt a first encoding and decoding mode to encode and decode. In response to the notification message being used for indicating that the parameter value of the QNC becomes better, the application program is controlled to adopt a second encoding and decoding mode to encode and decode. “Encoding and decoding” here refers to at least one of encoding and decoding.

A calculation duration of the same encoding and decoding task under the first encoding and decoding strategy is shorter than a calculation duration under the second encoding and decoding strategy.

For example, when the PDR increases, although the network delay increases, the application program may compensate for the deterioration of the network delay by reducing the internal calculation time, and the overall transmission delay can still be kept unchanged or changed very little. For example, the PDR of the non-GBR QoS flow corresponding to a video becomes worse, an encoding rate of the video is reduced, so as to reduce the number and/or size of video data packets.

A second possible implementation:

In response to notification message being used for indicating that the parameter value of the QNC becomes worse, the application program is controlled to be performed according to a first flow strategy. In response to the notification message being used for indicating that the parameter value of the QNC becomes better, the application program is controlled to be performed according to a second flow strategy. The flow of the first flow strategy is less than the flow of the second flow strategy.

Exemplarily, the flow of the application program includes a voice data packet and a video data packet.

In response to the notification message being used for indicating that the parameter value of the QNC becomes worse, a first flow corresponding to the voice data packet is kept, and a second flow corresponding to the video data packet is reduced. In response to the notification message being used for indicating that the parameter value of the QNC becomes better, the first flow corresponding to the voice data packet is kept, and the second flow corresponding to the video data packet is increased.

For example, when the PDR increases, the flow of a first non-GBR QoS flow corresponding to the video is reduced, and the flow of a second non-GBR QoS flow corresponding to the voice is kept, so that less radio resources are occupied as a whole, so as to improve the transmission quality of the voice data packet and reduce interference.

This is due to the fact that in cloud-based applications (video conferencing, voice conferencing and distance learning), two-way interaction of video and voice is often required. There are certain requirements for network transmission delay (usually one-way transmission delay is less than 150 ms), but in actual use process, due to changes of a wireless network status, the transmission delay of a wireless network suddenly deteriorates or the transmission rate suddenly decreases within a period of time (such as a 5-second period), resulting in audio and video jamming.

However, relevant studies show that users are very sensitive to audio jamming, but not too sensitive to video quality changes (such as resolution changes and clarity changes) (and it is acceptable to temporarily turn off the video while retaining voice). For audio, it is unlikely to get jammed due to its small transmission data. However, if the audio is jammed, the experience of the users is very poor. In addition, even if the audio quality drops from the CD quality to a very low transmission rate (such as 2G voice transmission quality), as long as there is no jam, the users still have a very good user experience.

To sum up, according to the method provided by the embodiment, the application program is adjusted through the application entity according to the parameter value of the changed QNC, so that when the relevant parameters of the non-GBR bearing flow become worse, or the relevant parameters of the non-GBR bearing flow become better from worse, the application entity can adapt to the parameter change by adjusting its internal application program, so as to optimize the operation of the application program.

According to the method provided by the embodiment, when the relevant parameters of the non-GBR bearing flow become worse, the calculation strategy of the application program is changed, the deterioration of the network delay is compensated by reducing the internal calculation duration of the application program, and the overall transmission delay can still be kept unchanged or changed very little.

According to the method provided by the embodiment, when the relevant parameters of the non-GBR bearing flow become worse, the flow strategy of the application program is changed, for example, the flow of the voice data packet is kept, and the flow of the video data packet is reduced, so that audio jamming which has a great influence on the user experience can be avoided, and the user experience when using audio and video programs is improved as much as possible.

### 2. A Configuration Process of QNC:

During the establishment or modification of the non-GBR bearing flow, a core network entity performs the configuration process of the QNC to an access network device. That is, the core network entity transmits a QNC profile to the access network device, the QNC profile being used for configuring the parameter of the QNC and the reporting condition (or change threshold, quick change threshold, change reporting threshold and quick change reporting threshold).

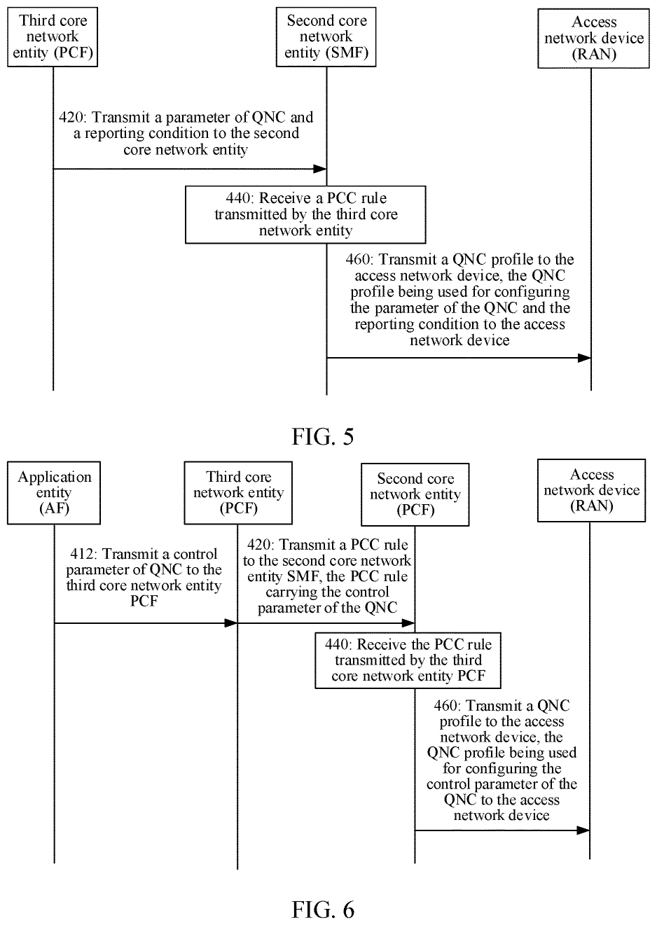

FIG. 5 is a flowchart of a configuration method of QNC provided by an exemplary embodiment of this disclosure. This embodiment is described by using an example in which the method is applied to the communication system shown in FIG. 1 or FIG. 2. The method includes:
Step 420: transmit, by a third core network entity, a parameter of QNC and a reporting condition to a second core network entity.

The third core network entity is an entity responsible for strategy management in the Core, such as a PCF.

The second core network entity is an entity responsible for session management in the Core, such as an MME is a 4G system or an SMF in a 5G system.

Exemplarily, during the establishment or modification of the non-GBR bearing flow, the third core network entity PCF transmits the parameter of the QNC and the reporting condition to the second core network entity SMF.

Exemplarily, in the process of establishing a protocol data unit (PDU) session, a (first) QoS flow may be established, and the QoS flow is called a QoS flow with default QoS rules. Generally speaking, the QoS flow is non-GBR type, and the third core network entity can provide the parameter of the QNC and the reporting condition to the second core network entity.

Exemplarily, the parameter of the QNC and the reporting condition are determined by the third core network entity itself. Or, the parameter of the QNC and the reporting condition are determined by the third core network entity based on service flow information transmitted by the application entity. Or, the parameter of the QNC and the reporting condition are determined by the third core network entity based on designing data of the UE.
Step 440: receive, by the second core network entity, a PCC rule transmitted by the third core network entity (PCF).
Step 460: transmit, by the second core network entity, a QNC profile to the access network device, the QNC profile being used for configuring the parameter of the QNC and the reporting condition to the access network device.

To sum up, according to the method provided by the embodiment, the third core network entity transmits the parameter of the QNC and the reporting condition to the second core network entity, so that the second core network entity can be triggered to configure the parameter of the QNC and the reporting condition for the non-GBR bearing flow, so as to complete the configuration process of the QNC.

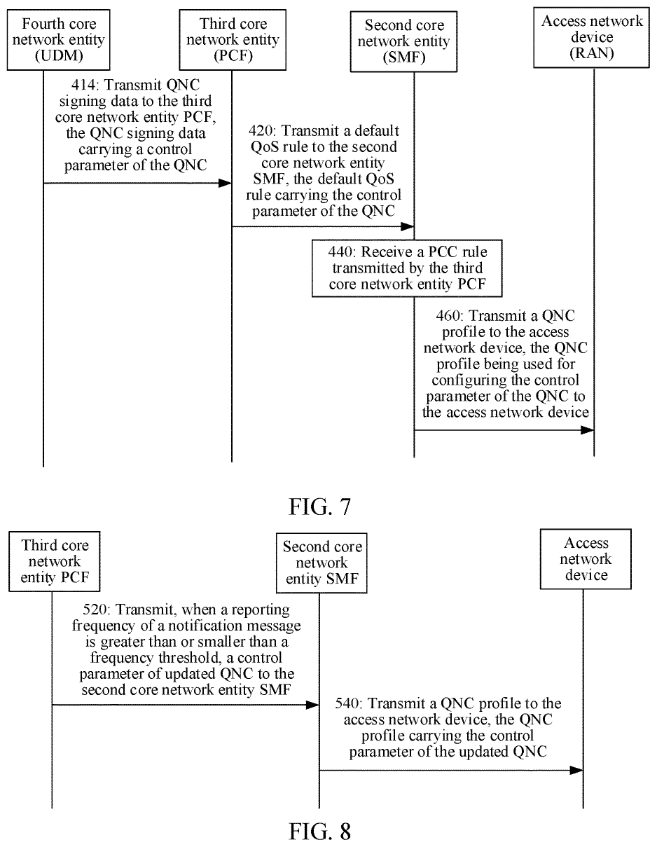

In a design, the application entity provides the service flow information for the third core network entity, and the service flow information carries the parameter of the QNC and the reporting condition that the application entity needs (or suggests), as shown in FIG. 6. In another design, the third core network entity determines the parameter of the QNC and the reporting condition based on the designing data of the QNC, as shown in FIG. 7.

FIG. 6 is a flowchart of a configuration method of QNC provided by another exemplary embodiment of this disclosure. This embodiment is described by using an example in which the method is applied to the communication system shown in FIG. 1 or FIG. 2. The method includes:
Step 412: transmit, by an application entity, a control parameter of QNC to a third core network entity.

The application entity AF transmits the service flow information to the third core network entity PCF, and the service flow information carries the control parameter of the QNC.

Exemplarily, the control parameter of the QNC includes: at least one of whether to enable the QNC, a parameter of QNC and a change threshold.
Step 420: transmit, by the third core network entity, a policy control and charging (PCC) rule to the second core network entity, the PCC rule carrying the control parameter of the QNC.
Step 440: receive, by the second core network entity, the PCC rule transmitted by the third core network entity (PCF).
Step 460: transmit, by the second core network entity, a QNC profile to the access network device, the QNC profile being used for configuring the control parameter of the QNC to the access network device.

To sum up, according to the method provided by the embodiment, the application entity provides the control parameter of the QNC for the third core network entity, so that active interaction between the application entity and the core network entity can be realized, the application entity drives the access network device (such as 5G, and RAN of 4G) to report the quick changes of the non-GBR bearing flow, thus the network capabilities are opened to the application entity through the radio access network, and a new way is provided for the innovation of Internet applications.

FIG. 7 is a flowchart of a configuration method of QNC provided by another exemplary embodiment of this disclosure. This embodiment is described by using an example in which the method is applied to the communication system shown in FIG. 1 or FIG. 2. The method includes:
Step 414: transmit, by a fourth core network entity, QNC signing data to a third core network entity, the QNC signing data carrying a control parameter of the QNC.

The fourth core network entity is a core network entity responsible for designing data management.

If default 5QI is an NGBR type, the fourth core network entity adds the QNC designing data. The fourth core network entity transmits the QNC designing data to the second core network entity, and the second core network entity transmits the QNC designing data to the third core network entity.
Step 420: transmit, by the third core network entity, a default QoS rule to the second core network entity, the default QoS rule carrying the control parameter of the QNC.
Step 440: receive, by the second core network entity, the PCC rule transmitted by the third core network entity PCF.
Step 460: transmit, by the second core network entity, a QNC profile to the access network device, the QNC profile being used for configuring the control parameter of the QNC to the access network device.

To sum up, according to the method provided by the embodiment, the third core network entity determines the control parameter of the QNC based on the designing data of the UE, so that the 5G network can be driven to report the quick changes of the non-GBR bearing flow to the AF and/or the UE based on the designing data of the UE.

### 3. An Optimization Process of QNC:

When the third core network entity PCF or the application entity AF finds that the notification messages of the QNC are too frequent, and a large amount of signaling is caused to a system. At this time, the third core network entity PCF or the application entity AF needs to modify the reporting condition of the QNC, such as increasing the change threshold.

FIG. 8 is a flowchart of an optimization method of QNC provided by an exemplary embodiment of this disclosure. This embodiment is described by using an example in which the method is applied to the communication system shown in FIG. 1 or FIG. 2. The method includes:
Step 520: transmit, when a reporting frequency of a notification message is greater than or less than a frequency threshold, a control parameter of updated QNC to a second core network entity by a third core network entity.

The control parameter of the updated QNC includes: at least one of whether to enable the QNC, a parameter of the updated QNC and an updated change threshold. That is, the control parameter of the updated QNC can update at least one of the whether to enable the QNC, the parameter of the updated QNC and the updated change threshold.

For example, the third core network entity transmits, when the reporting frequency of the notification message is greater than the frequency threshold, an indication to enable the QNC to the second core network entity. In another example, the third core network entity transmits, when the reporting frequency of the notification message is greater than the frequency threshold, a parameter of reduced QNC to the second core network entity. For yet another example, the third core network entity PCF transmits, when the reporting frequency of the notification message is greater than the frequency threshold, an increased change threshold to the second core network entity.
Step 540: transmit, by the second core network entity, a QNC profile to the access network device, the QNC profile carrying the control parameter of the updated QNC.

To sum up, according to the method provided by the embodiment, when the reporting frequency of the notification message is greater than or less than the frequency threshold, the control parameter of the updated QNC is transmitted to the second core network entity SMF and the access network device, so that large signaling overhead caused to the system can be avoided, or a notification mechanism of the QNC is properly used.

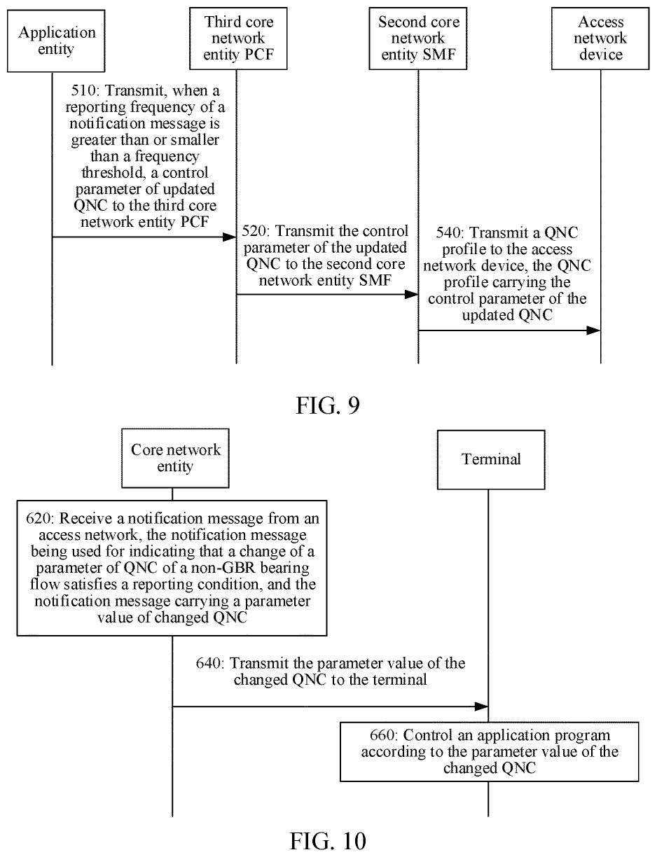

FIG. 9 is a flowchart of an optimization method of QNC provided by another exemplary embodiment of this disclosure. This embodiment is described by using an example in which the method is applied to the communication system shown in FIG. 1 or FIG. 2. The method includes:
Step 510: transmit, when a reporting frequency of a notification message is greater than or smaller than a frequency threshold, a control parameter of updated QNC to a third core network entity PCF by an application entity.

The control parameter of the updated QNC includes: at least one of whether to enable the QNC, a parameter of the updated QNC and an updated change threshold. That is, the control parameter of the updated QNC can update at least one of the whether to enable the QNC, the parameter of the updated QNC and the updated change threshold.

For example, the AF transmits, when the reporting frequency of the notification message is greater than or less than the frequency threshold, an indication to enable the QNC to the third core network entity PCF. In another example, the AF transmits, when the reporting frequency of the notification message is greater than the frequency threshold, a parameter of reduced QNC to the third core network entity PCF. For yet another example, the AF transmits, when the reporting frequency of the notification message is greater than the frequency threshold, an increased change threshold to the third core network entity PCF.
Step 520: transmit, by the third core network entity, a control parameter of the updated QNC to the second core network entity.
Step 540: transmit, by the second core network entity, a QNC profile to the access network device, the QNC profile carrying the control parameter of the updated QNC.

To sum up, according to the method provided by the embodiment, when the reporting frequency of the notification message is greater than or less than the frequency threshold, the AF triggers the PCF to transmit the control parameter of the updated QNC to the second core network entity SMF and the access network device, so that large signaling overhead caused to the system can be avoided, or a notification mechanism of the QNC is properly used.

### 4. A Notification Process of Parameter Value of QNC (for UE):

FIG. 10 is a flowchart of a method for notifying a parameter value of QNC provided by an exemplary embodiment of this disclosure. This embodiment is described by using an example in which the method is applied to the communication system shown in FIG. 1 or FIG. 2. The method includes:
Step 620: receive, by a core network entity, a notification message from an access network device, the notification message being used for indicating that a change of a parameter of QNC of a non-GBR bearing flow satisfies a reporting condition, and the notification message carrying a parameter value of changed QNC.
Step 640: transmit, by the core network entity, the parameter value of the changed QNC to the terminal.

Taking the core network entity is the SMF as an example, after the SMF receives the notification message of the access network device, the parameter value of the changed QNC is transmitted to the UE.

Illustratively, when the SMF does not receive a new PCC rule transmitted by the PCF within a predetermined duration after receiving the notification message, it transmits the parameter value of the changed QNC to the terminal.

Illustratively, when the SMF receives the new PCC rule transmitted by the PCF within the predetermined duration after receiving the notification message, and there is no modification on the QoS profile in the new PCC rule, it transmits the parameter value of the changed QNC to the terminal.

The parameter value of the changed QNC is transmitted to the terminal through the RAN from the core network device. In an embodiment, the core network entity transmits an NAS message to the UE, the terminal receives the NAS message transmitted by the core network entity, and the NAS message carries the parameter value of the changed QNC. In an embodiment, the core network entity transmits a PDU session modification command to the terminal, the terminal receives the PDU session modification command transmitted by the core network entity, and the PDU session modification command carries a parameter value of changed QCQNC.
Step 660: control, by the terminal, an application program according to the parameter value of the changed QNC.

The UE controls at least one of a calculation strategy and a flow strategy of the application program according to the parameter value of changed QNC, so as to make the application program adapt to the quick change of related parameters of the non-GBR bearing flow.

Taking an application program on a UE side of an online session as an example, the application program corresponds to 4 SDFs: a voice SDF, a video SDF, a text message SDF and a control plane SDF. The 4 SDFs correspond to 4 non-GBR QoS flows, and QNC mechanisms are enabled for the 4 non-GBR QoS flows respectively.

A first possible implementation:
in response to the parameter value of the changed QNC becoming worse, the application program is controlled to be performed according to a first calculation strategy.

In response to the parameter value of the changed QNC becoming better, the application program is controlled to be performed according to a second calculation strategy.

A calculation duration of the same calculation task under the first calculation strategy is shorter than a calculation duration under the second calculation strategy.

The calculation strategy is a strategy related to the running calculation of the application program. The calculation strategy includes, but is not limited to: at least one of a selection strategy of an encoding and decoding mode, a selection strategy of an encoding and decoding model, a selection strategy of an encoding and decoding level, a selection strategy of a compression level and a selection strategy of a neural network model.

Taking the calculation strategy including the selection of an encoding and decoding mode as an example, in response to the parameter value of the changed QNC becoming worse, the application program is controlled to adopt a first encoding and decoding mode to encode and decode. In response to the parameter value of the changed QNC becoming better, the application program is controlled to adopt a second encoding and decoding mode to encode and decode. “Encoding and decoding” here refers to at least one of encoding and decoding.

A calculation duration of the same encoding and decoding task under the first encoding and decoding strategy is shorter than a calculation duration under the second encoding and decoding strategy.

For example, when the PDR increases, although the network delay increases, the application program may compensate for the deterioration of the network delay by reducing the internal calculation time, and the overall transmission delay can still be kept unchanged or changed very little. For example, the PDR of the non-GBR QoS flow corresponding to a video becomes worse, an encoding rate of the video is reduced, so as to reduce the number and/or size of video data packets.

A second possible implementation:
in response to the parameter value of the changed QNC becoming worse, the application program is controlled to be performed according to a first flow strategy.

In response to the parameter value of the changed QNC becoming better, the application program is controlled to be performed according to a second flow strategy.

The flow of the first flow strategy is less than the flow of the second flow strategy.

Exemplarily, the flow of the application program includes a voice data packet and a video data packet.

In response to the parameter value of the changed QNC becoming worse, a first flow corresponding to the voice data packet is kept, and a second flow corresponding to the video data packet is reduced. In response to the parameter value of the changed QNC becoming better, the first flow corresponding to the voice data packet is kept, and the second flow corresponding to the video data packet is increased.

For example, when the PDR increases, the flow of a first non-GBR QoS flow corresponding to the video is reduced, and the flow of a second non-GBR QoS flow corresponding to the voice is kept, so that less radio resources are occupied as a whole, so as to improve the transmission quality of the voice data packet and reduce interference. In the process of reducing the flow of the first non-GBR QoS flow, both the UE side and the AF side may change the video encoding and decoding mode to reduce the number and/or size of the video data packet.

This is due to the fact that in cloud-based applications (video conferencing, voice conferencing and distance learning), two-way interaction of video and voice is often required. There are certain requirements for network transmission delay (usually one-way transmission delay is less than 150 ms), but in actual use process, due to changes of a wireless network status, the transmission delay of a wireless network suddenly deteriorates or the transmission rate suddenly decreases within a period of time (such as a 5-second period), resulting in audio and video jamming.

However, relevant studies show that users are very sensitive to audio jamming, but not too sensitive to video quality changes (such as resolution changes and clarity changes) (and it is acceptable to temporarily turn off the video while retaining voice). For audio, it is unlikely to get jammed due to its small transmission data. However, if the audio is jammed, the experience of the users is very poor. In addition, even if the audio quality drops from the CD quality to a very low transmission rate (such as 2G voice transmission quality), as long as there is no jam, the users still have a very good user experience.

To sum up, according to the method provided by the embodiment, the application program is adjusted through the UE according to the parameter value of the changed QNC, so that when the relevant parameters of the non-GBR bearing flow become worse, or the relevant parameters of the non-GBR bearing flow become better from worse, the UE can adapt to the parameter change by adjusting its internal application program, so as to optimize the operation of the application program.

According to the method provided by the embodiment, when the relevant parameters of the non-GBR bearing flow become worse, the calculation strategy of the application program is changed, the deterioration of the network delay is compensated by reducing the internal calculation duration of the application program, and the overall transmission delay can still be kept unchanged or changed very little.

According to the method provided by the embodiment, when the relevant parameters of the non-GBR bearing flow become worse, the flow strategy of the application program is changed, for example, the flow of the voice data packet is kept, and the flow of the video data packet is reduced, so that audio jamming which has a great influence on the user experience can be avoided, and the user experience when using audio and video programs is improved as much as possible.

### 5. QNC Control in a Handover Process:

The handover process is the most common factor that causes the quick change of parameters of the QNC, so it is necessary to introduce a QNC mechanism for a non-GBR bearing flow in the handover process.

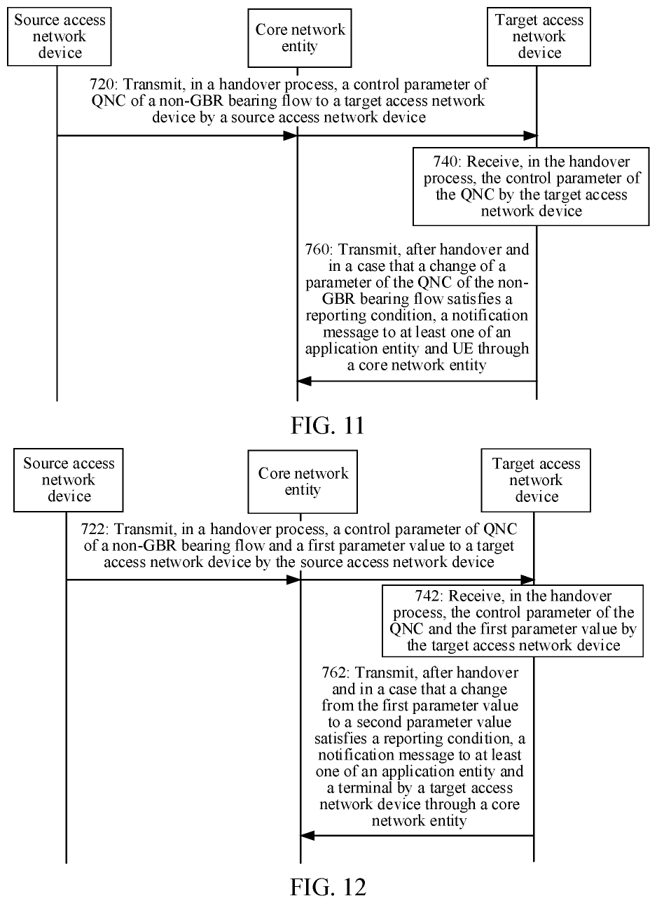

FIG. 11 is a flowchart of a message transmission method based on a handover process in the handover process provided by an exemplary embodiment of this disclosure. This embodiment is described by using an example in which the method is applied to the communication system shown in FIG. 1 or FIG. 2. The method includes:
Step 720: transmit, in a handover process, a control parameter of QNC of a non-GBR bearing flow to a target access network device by a source access network device.

The control parameter of the QNC is used for indicating the parameter of the QNC of the non-GBR bearing flow and a reporting condition.
Step 740: receive, in the handover process, the control parameter of the QNC by the target access network device.

The target access network device enables or starts the QNC of the non-GBR bearing flow according to the control parameter of the QNC.
Step 760: transmit, after handover and when a change of a parameter value of the QNC of the non-GBR bearing flow satisfies a reporting condition, a notification message to an application entity by the target access network device through a core network entity.

The change of the parameter value of the QNC includes at least one of the following:
1. A change from a first parameter value to a second parameter value;
the first parameter value is a parameter value of the parameter of the QNC before handover, namely a current parameter value of the source access network device; and the second parameter value is a parameter value of the parameter of the QNC after handover, namely a current parameter value of the target access network device.
2. A change from the second parameter value to a third parameter value.

The second parameter value and the third parameter value are both parameter values of the parameter of the QNC after handover, and a collection time of the third parameter value is later than the second parameter value.

To sum up, since the handover process is the most likely process to cause quick changes in the wireless network status, according to the method provided by the embodiment, the source access network device transmits the control parameter of the QNC of the non-GBR bearing flow to the target access network device, so that the target access network device can transmit, when the increase/decrease of the parameter of the QNC of the non-GBR bearing flow satisfies the reporting condition, the notification message to the application entity and the terminal through the core network entity, thus, when the relevant parameters of the non-GBR bearing flow become worse, or the relevant parameters of the non-GBR bearing flow become better from worse, the application entity can adapt to the parameter change by adjusting its internal application program, so as to optimize the operation of the application program and the terminal.

Exemplarily, in the handover process, the source access network device transmits the control parameter of the QNC of the non-GBR bearing flow to the target access network device through the core network entity. In different communication systems, the type, number and division of the core network entity may be different. Taking a 5G system as an example, the core network entity includes: a first core network entity AMF and a second core network entity SMF. The process that the source access network device transmits the control parameter of the QNC of the non-GBR bearing flow to the target access network device through the core network entity, includes the following steps:
1. transmit, in a handover process, a handover request to a source first core network entity AMF by a source access network device, the handover request carrying a control parameter of QNC;
2. transmit, by the source first core network entity AMF, an Namf_Communication_CreateUEContext request to a target first core network entity AMF, the Namf_Communication_CreateUEContext request carrying the control parameter of the QNC;
3. transmit, by the target first core network entity AMF, an Nsmf_PDUSession_UpdateSMContext request to a second core network entity SMF, the Nsmf_PDUSession_UpdateSMContext request carrying the control parameter of the QNC;
4. transmit, by the second core network entity SMF, an Nsmf_PDUSession_UpdateSMContext response to the target first core network entity AMF, the Nsmf_PDUSession_UpdateSMContext response carrying the control parameter of the QNC; and
5. transmit, by the target first core network entity AMF, a handover request to the target access network device, the handover request carrying the control parameter of the QNC.

The control parameter of the QNC may be carried in a source-to-end transparent transmission container. The source-to-end transparent transmission container is a field that is transparently transmitted in the handover request, the Namf_Communication_CreateUEContext request, the Nsmf_PDUSession_UpdateSMContext request, the Nsmf_PDUSession_UpdateSMContext response and the handover request.

FIG. 12 is a flowchart of a message transmission method based on a handover process provided by an exemplary embodiment of this disclosure. This embodiment is described by using an example in which the method is applied to the communication system shown in FIG. 1 or FIG. 2. The method includes:
Step 722: transmit, in a handover process, a control parameter of QNC of a non-GBR bearing flow and a first parameter value to a target access network device by a source access network device.

Compared with the embodiment in FIG. 3, the source access network device not only transmits the control parameter of the QNC to the target access network device, but also transmits the first parameter value to the target access network device at the same time, and the first parameter value is the parameter value of the parameter of the QNC before handover.

The control parameter of the QNC and the first parameter value may be transmitted in the same message or in different messages. In this disclosure, the situation that the control parameter of the QNC and the first parameter value are transmitted in the same message is taken as an example.

Exemplarily, in the handover process, the source access network device transmits the control parameter of the QNC of the non-GBR bearing flow and the first parameter to the target access network device through the core network entity. In different communication systems, the type, number and division of the core network entity may be different. Taking a 5G system as an example, the core network entity includes: a first core network entity AMF and a second core network entity SMF. The process that the source access network device transmits the control parameter of the QNC of the non-GBR bearing flow and the first parameter value to the target access network device through the core network entity, includes the following steps:
1. transmit, in a handover process, a handover request to a source first core network entity AMF by a source access network device, the handover request carrying a control parameter of QNC;
2. transmit, by the source first core network entity AMF, an Namf_Communication_CreateUEContext request to a target first core network entity AMF, the Namf_Communication_CreateUEContext request carrying the control parameter of the QNC and the first parameter value;
3. transmit, by the target first core network entity AMF, an Nsmf_PDUSession_UpdateSMContext request to a second core network entity SMF, the Nsmf_PDUSession_UpdateSMContext request carrying the control parameter of the QNC and the first parameter value;
4. transmit, by the second core network entity SMF, an Nsmf_PDUSession_UpdateSMContext response to the target first core network entity AMF, the Nsmf_PDUSession_UpdateSMContext response carrying the control parameter of the QNC and the first parameter value; and
5. transmit, by the target first core network entity AMF, a handover request to the target access network device, the handover request carrying the control parameter of the QNC and the first parameter value.

In an embodiment, the control parameter of the QNC and the first parameter value are carried in the source-to-end transparent transmission container. The source-to-end transparent transmission container is a field that is transparently transmitted in the handover request, the Namf_Communication_CreateUEContext request, the Nsmf_PDUSession_UpdateSMContext request, the Nsmf_PDUSession_UpdateSMContext response and the handover request.
Step 742: receive, in the handover process, the control parameter of the QNC and the first parameter value by the target access network device.

Exemplarily, in addition to the control parameter of the QNC transmitted by the source access network device to the target access network device, the handover request may further carry the control parameter of the QNC transmitted by the second core network entity SMF to the target access network device.

The control parameters of the two groups of QNC are carried in different fields of the handover request. Exemplarily, the control parameter of the QNC transmitted by the source access network device to the target access network device is carried in a source-to-end transparent transmission container of the handover request; and the control parameter of the QNC transmitted by the second core network entity SMF to the target access network device is carried in the handover request.

Usually, the control parameters of the two groups of QNC are consistent. However, if the control parameters of the two groups of QNC are inconsistent, the target access network device takes the control parameter of the QNC transmitted by the second core network entity SMF to the target access network device as the priority.
Step 762: transmit, after handover and when a change from the first parameter value to a second parameter value satisfies a reporting condition, a notification message to an application entity by a target access network device through a core network entity.

The first parameter value is a parameter value of the parameter of the QNC before handover, and the second parameter value is a parameter value of the parameter of the QNC after handover.

To sum up, according to the method provided by the embodiment, the source access network device transmits the first parameter value of the non-GBR bearing flow to the target access network device, so that the target access network device can monitor the increase/decrease of the parameter of the QNC of the non-GBR bearing flow before and after handover, if the change of the parameter of the QNC before and after handover satisfies the reporting condition, the target access network device transmits the notification message to the application entity and the terminal through the core network entity, thus, when the relevant parameters of the non-GBR bearing flow become worse, or the relevant parameters of the non-GBR bearing flow become better from worse, the application entity can adapt to the parameter change by adjusting its internal application program, so as to optimize the operation of the application program and the terminal.

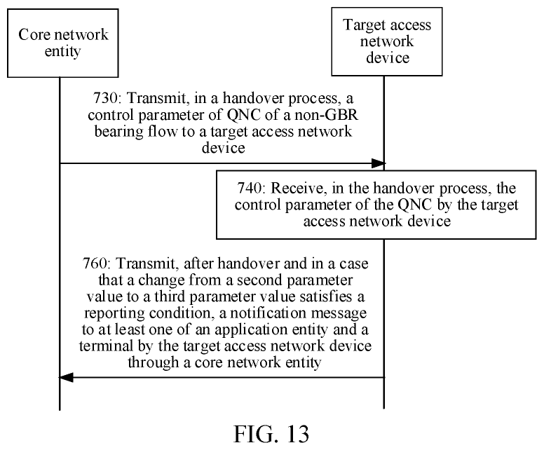

It needs to be illustrated that, in some cases, the source access network device or one of the source access network devices does not support the QNC of the non-GBR bearing flow, and the target access network device supports the QNC of the non-GBR bearing flow. This disclosure further provides the following embodiments, as shown in FIG. 13.
Step 730: transmit, in a handover process, a control parameter of QNC of a non-GBR bearing flow to a target access network device by a core network entity.

After the core network entity receives a handover request of the source access network device, if the handover process involves the handover of the non-GBR bearing flow, the core network entity may add the control parameter of the QNC to the handover request.

Exemplarily, the SMF adds the control parameter of the QNC to a QoS establishment request entry of the handover request. The control parameter of the QNC includes: whether to enable the QNC, a parameter of the QNC and a reporting condition.
Step 740: receive, in the handover process, the control parameter of the QNC by the target access network device.

The target access network device enables or starts the QNC of the non-GBR bearing flow according to the control parameter of the QNC.
Step 760: transmit, after handover and when a change from the second parameter value to a third parameter value satisfies a reporting condition, a notification message to an application entity by the target access network device through a core network entity.

The second parameter value and the third parameter value are both parameter values of the parameter of the QNC after handover, and a collection time of the third parameter value is later than the second parameter value.

To sum up, according to the method provided by the embodiment, the core network entity transmits the control parameter of the QNC of the non-GBR bearing flow to the target access network device, when the source access network device does not support the QNC of the non-GBR bearing flow, the target access network device may also be triggered to control the QNC of the non-GBR bearing flow. Therefore, the QNC control of the non-GBR bearing flow may be introduced in a handover scene that is most likely to cause quick change of the parameter of the QNC, and the control of the application program is enhanced, so that the application program can better adapt to network changes.

The steps performed by the access network device may be separately implemented as one embodiment on the access network device side; and the steps performed by the core network entity may be separately implemented as one embodiment on the Core side; and the steps performed by the application entity may be separately implemented as one embodiment on the application entity side, and will not be repeated in this disclosure.

The above process will be described in more detail in combination with the communication protocol (TS23.502) of the third generation partnership project (3GPP). For details of the network cell name, step process and step introduction in the following drawings, reference may be made to the relevant records in TS23.502 (https://www.3gpp.org/ftp/Specs/archive/23_series/23.502). Due to the space limitation, this article focuses on the different contents between the embodiments of this disclosure and the TS23.502 protocol.

### 1. A Notification Process of QNC

When a network where UE is located changes, that is, a base station detects that radio resources change quickly (become better or worse). When the change reaches a change threshold defined by QNC, a RAN may trigger a notification process of the QNC, and transmit a notification message to an AF. In an embodiment, the notification message carries a parameter value (current parameter value) of the parameter of the changed QNC. The base station first transmits the notification message to an SMF, then the SMF transmits the notification message to a PCF, and the PCF transmits the notification message to the AF.

### 1.1 A Non-Roaming and Local Breakout Roaming Scene:

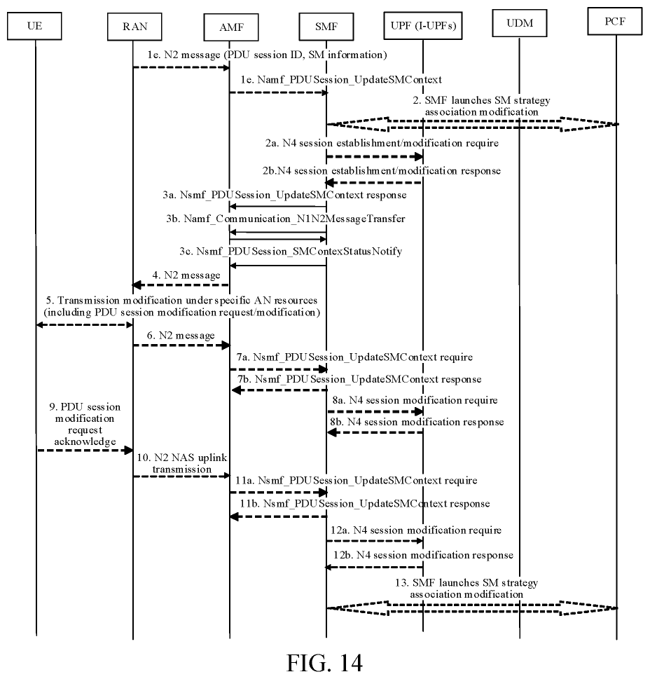

FIG. 14 illustrates a schematic diagram of a PDU session modification (for non-roaming and local breakout roaming) process requested by UE or a network provided by an exemplary embodiment of this disclosure.

In step 1e, the RAN transmits an N2 message (PDU session ID, SM information), and the AMF transmits an Namf_PDUSession_UpdateSMContext message to the SMF.

When the parameter of the QNC of a non-GBR bearing flow satisfies a reporting condition, the 2 messages carry the notification message. In an embodiment, the notification message further carries the parameter value of the changed QNC.

In step 2, the SMF launches an SM strategy association modification process, and transmits the notification message to the PCF and the AF.

In step 5, the SMF transmits a PDU session modification request to the UE, and transmits the parameter value of the changed QNC to the UE.

Exemplarily, after the SMF receives the notification message for a period of time, when the SMF does not receive a new PCC rule of the PCF or the PCC rule of the SDF corresponding to the QNC in the received PCC rule does not modify the QoS, the SMF launches a PDU session modification request to the UE, and notify the UE of the parameter value (PDB, PER and CBR) of current QCQNC of the QFI corresponding to the current QNC.

In step 9, the UE responds to a PDU session modification acknowledge.

The PDU session modification request and the PDU session modification acknowledge are transparently transmitted between the UE and the SMF through the RAN.

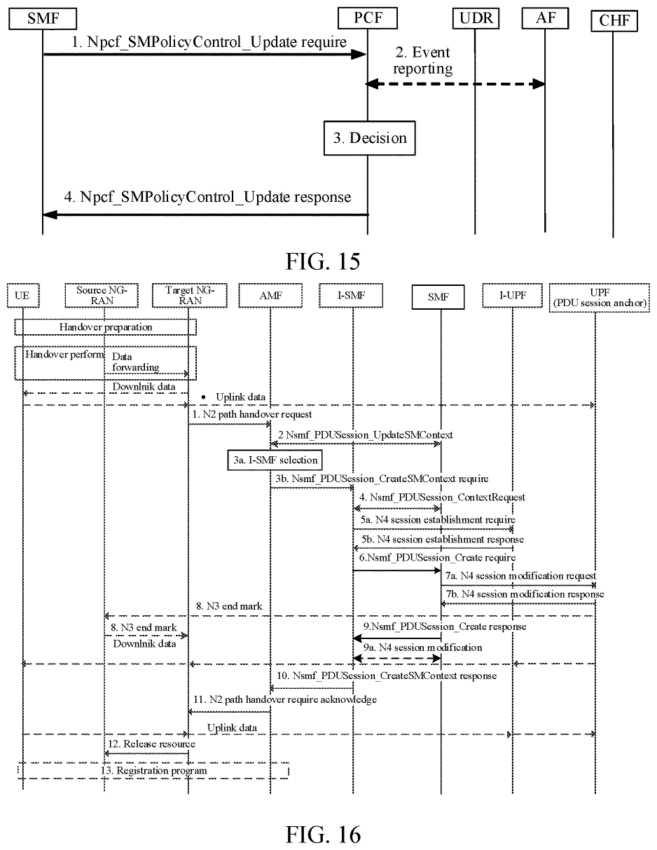

The SM strategy association modification process shown in step 2 is defined by FIG. 15. As shown in FIG. 15,
in step 1, the SMF transmits an Npcf_SMPolicyControl_Update request to the PCF, and the request carries the notification message.

In step 2, the PCF transmits an event reporting Npcf_PolicyAuthorizationNotify request to the AF, and the event reporting carries the notification message.

### 1.2 An Inter NG-RAN Handover Scene Based on an Xn Interface:

FIG. 16 illustrates a schematic diagram of an Xn-based inter NG-RAN handover process without UPF reallocation provided by an exemplary embodiment of this disclosure.

In the process of performing handover, a source NG-RAN transmits a QNC control parameter and a first parameter value of the QNC of the non-GBR bearing flow on a source side to a target NG-RAN, namely, a current parameter value of the parameter of the QNC before handover.

In step 1, the target NG-RAN transmits an N2 path handover request to the AMF, the request carries the notification message, and the notification message may carry a parameter value (second parameter value) of the QNC after handover.

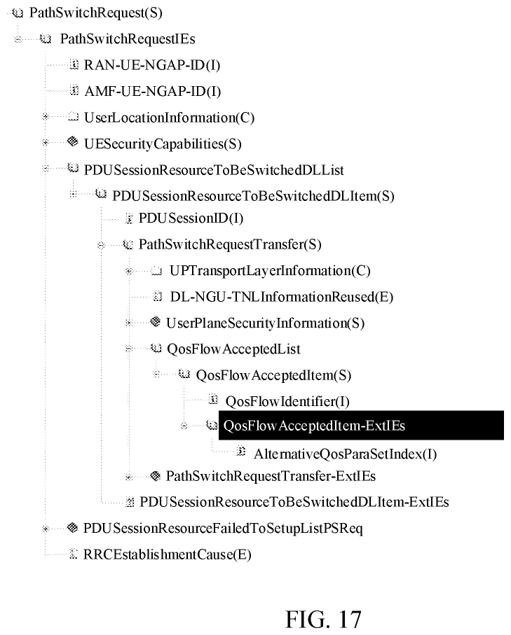

After the UE successfully hands over to the target NG-RAN, since a resource state of the target NG-RAN is certainly inconsistent with a resource state of the source NG-RAN, the target NG-RAN determines whether to report the notification message. When reporting is required, the parameter value of the QNC on the changed target NG-RAN may be included in a QoS Flow Accepted Item field in an N2 path handover request. A message structure of the N2 path handover request is shown in FIG. 17.

In step 2, the AMF transmits an Nsmf_PDUSession_UpdateSMContext request to the SMF, the request carries the notification message, and the notification message may carry the parameter value (second parameter value) of the QNC after handover.

Then, the SMF reports the notification message to the PCF and the AF based on the process shown in FIG. 13 and FIG. 14.

### 1.3 An N2 Handover Scene Based on an NG-RAN Node:

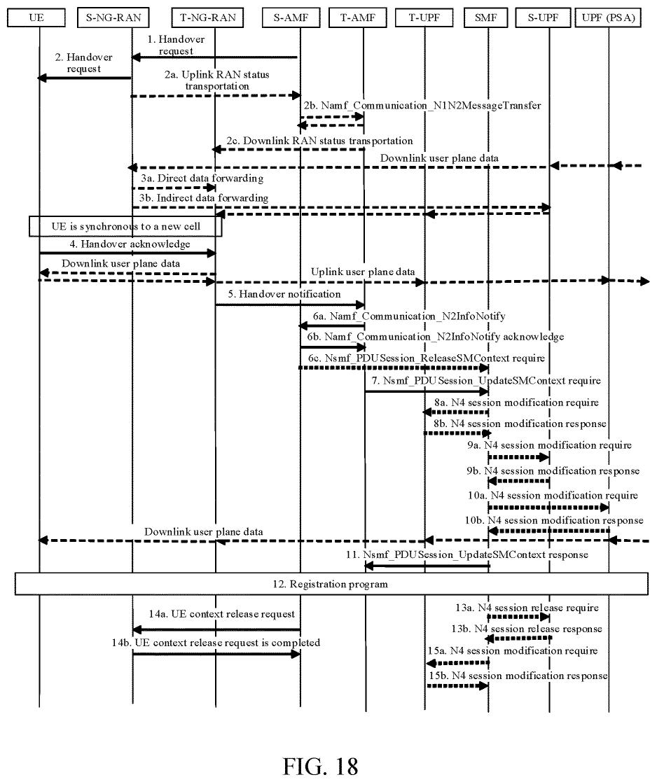

FIG. 18 illustrates a schematic diagram of an N2 handover process based on an NG-RAN node provided by an exemplary embodiment of this disclosure.

In step 5, a target NG-RAN transmits a handover notification to a target AMF, the handover notification carries a notification message, and the notification message may carry a parameter value (second parameter value) of QNC on the target NG-RAN after handover.

After the UE successfully hands over to the target NG-RAN, since a resource state of the target NG-RAN is certainly inconsistent with a resource state of the source NG-RAN, the target NG-RAN determines whether to report the notification message. When reporting is required, the handover notification may carry the notification message.

In step 7, the AMF transmits an Nsmf_PDUSession_UpdateSMContext request to the SMF, the request carries the notification message, and the notification message may carry the parameter value (second parameter value) of the QNC after handover.

Then, the SMF reports the notification message to the PCF and the AF based on the process shown in FIG. 14 and FIG. 15.

### 2. A Configuration Process of QNC

### 2.1 A PDU Session Establishment Scene for Non-Roaming and Local Breakout Roaming:

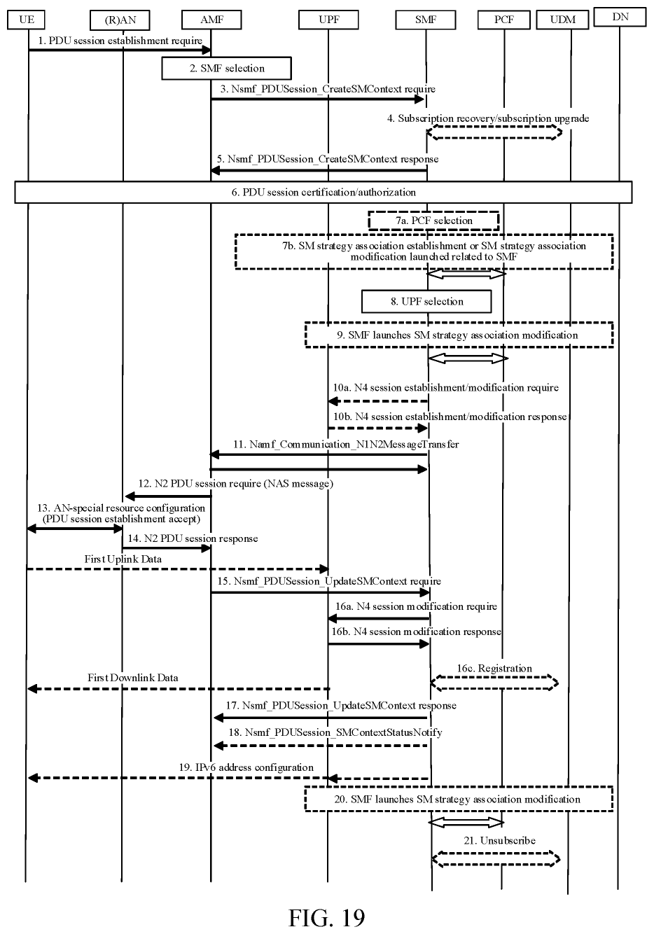

FIG. 19 illustrates a schematic diagram of a PDU session establishment process required by UE provided by an exemplary embodiment of this disclosure.

In steps 7b and 9, an SMF transmits an SM strategy association establishment request message or an SM strategy association modification request message to a PCF. Correspondingly, the PCF transmits an SM strategy association establishment response message to the SMF or launches an SM strategy association modification response message related to the SMF, and the message carries a control parameter of QNC.

In a process of establishing a PDU session, a QoS flow (usually the first) may be established, and the QoS flow is a QoS flow based on a default QoS rule (it is no longer similar to the default bearing of 4G, and 5G no longer uses the default QoS flow for naming).

Generally speaking, if the default QoS rule is non-GBR type, the PCF may include the control parameter of the QNC in the PCC rule. In step 7b or 9 of FIG. 18, if 5QI in the default QoS rule provided by the PCF is of NGBR type, the PCF can provide the control parameter of QCQNC to the SMF.

In steps 11 and 12, the SMF transmits an Namf_Communication_N1N2 information conversion message to the AMF, and the message carries a QNC profile according to the control parameter of the QCQNC provided by the PCF.

In an embodiment, designing data of the UE include a default 5QI and a default ARP. If the default 5QI is of the NGBR type, the QNC designing data are added.

In steps 4, 7b and 9, an UDM transmits a message including the QNC designing data to the SMF, then the SMF provides the QNC designing data to the PCF, and then the default QoS rule provided by the PCF includes the control parameter of the QNC.

The PDU session establishment process may be used for a PDU session handover from N3GPP to 3GPP. In step 7b or step 9, if the PCF provides the control parameter of the QNC for any non-GBR QoS flow, the control parameters of the QNC are added in steps 11 and 12 similar to the above.

It needs to be noticed that there may be processing of a plurality of non-GBR QoS flows.

It needs to be noticed that the parameters related to the SM in the N2 message of step 12 are included in step 11, so the control parameter of the QNC is included in step 11.

### 2.2 A Home Routing Roaming Scene:

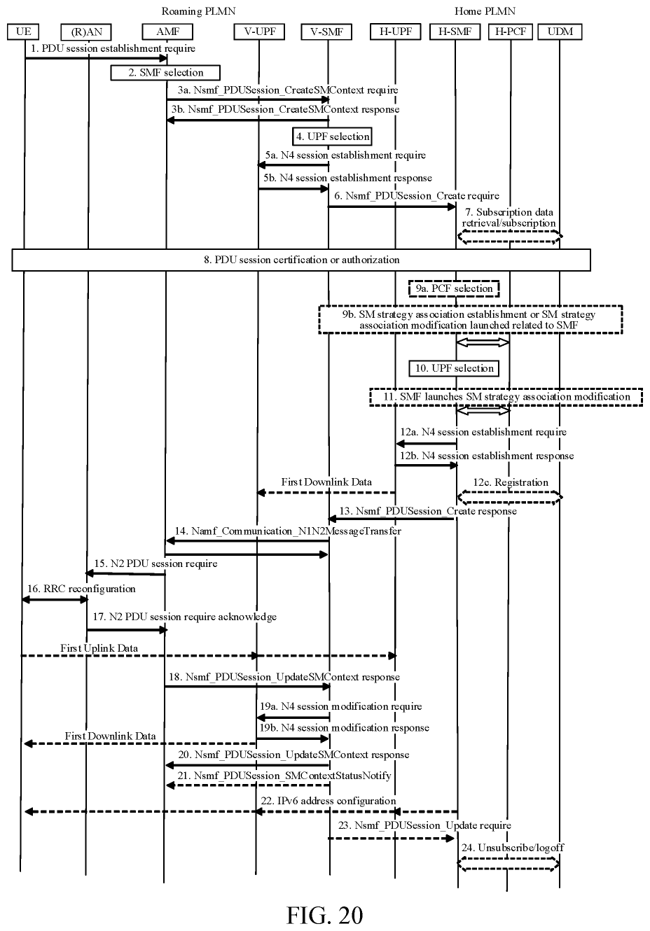

FIG. 20 illustrates a flowchart of a PDU session establishment process requested by UE in a home route roaming scenario provided by an exemplary embodiment of this disclosure.

In a process of establishing a PDU session, a QoS flow (usually the first) may be established, and the QoS flow is a QoS flow based on a default QoS rule (it is no longer similar to the default bearing of 4G, and 5G no longer uses the default QoS flow for naming).

Generally speaking, if the default QoS rule is non-GBR type, the PCF may include the control parameter of the QNC in the PCC rule. In the message of step 9b or 11 of FIG. 19, if 5QI in the default QoS rule provided by the PCF is of the non-GBR type, the PCF can provide the control parameter of the QNC. Then, the QNC profile is added in the messages in steps 13, 14 and 15.

In an embodiment, designing data of the UE include a default 5QI and a default ARP. If the default 5QI is of the NGBR type, the QNC designing data are added.

In step 7, step 9b and step 11, the UDM provides the designing data of QNC to the SMF, the SMF provides the designing data of the QNC to the PCF, and then the default QoS rule provided by the PCF includes the control parameter of the QNC.

### 2.3 An AF-Triggered QoS Flow Establishment Process, a Non-Roaming and Local Breakout Roaming Scene:

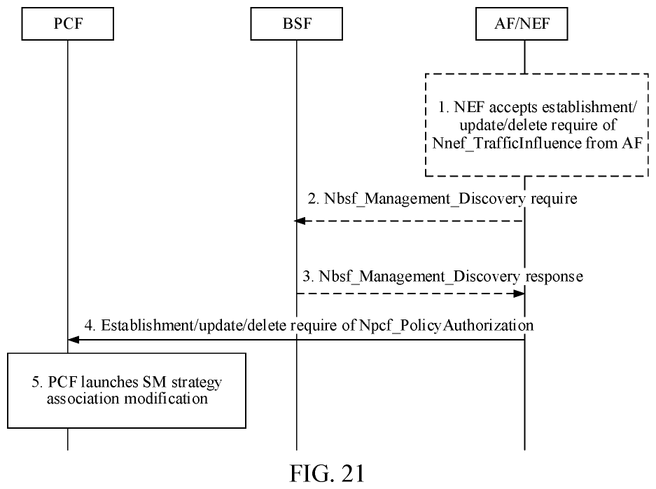

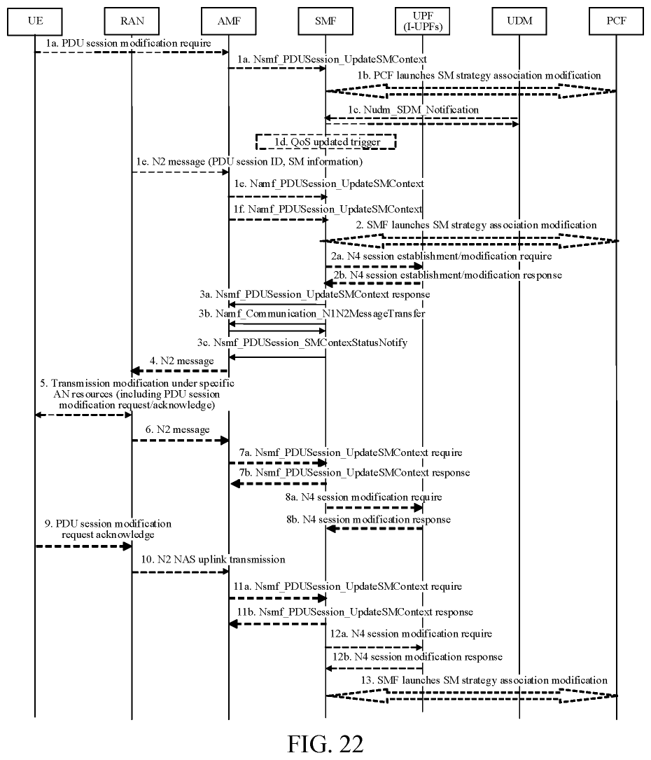

FIG. 21 illustrates a schematic diagram of a process of transferring an AF request for a single UE address to a related PCF provided by an exemplary embodiment of this disclosure. FIG. 22 illustrates a schematic diagram of a PDU session modification process requested by UE or a network for non roaming and local breakout roaming provided by an exemplary embodiment of this disclosure.

In step 4 of FIG. 21, the AF transmits an Npcf_PolicyAuthorization_Create/Update message to the PCF, and the control parameter of the QNC is added in information of (one or more) media components included in the message. As mentioned above, if the media component includes the control parameter of the QNC, it is required that the media is transmitted on the NGBR; and If the media component does not include the QCQNC parameter, it indicates that the media may be transmitted on the NGBR, or on a GBR QoS flow (GBF).

In step 1b of FIG. 22, the PCF transmits an Npcf_SMPolicyControlUpdateNotify request message. In the request message, the control parameter of the QNC is added in the PCC rule of (one or more) service data flow (SDF, one SDF corresponds to one media flow provided by the AF).

Correspondingly, the messages in steps 3b and 4 of FIG. 22 carry the control parameters of the QNC.

### An AF-Triggered QoS Flow Establishment Process, a Home Routing Roaming Scene:

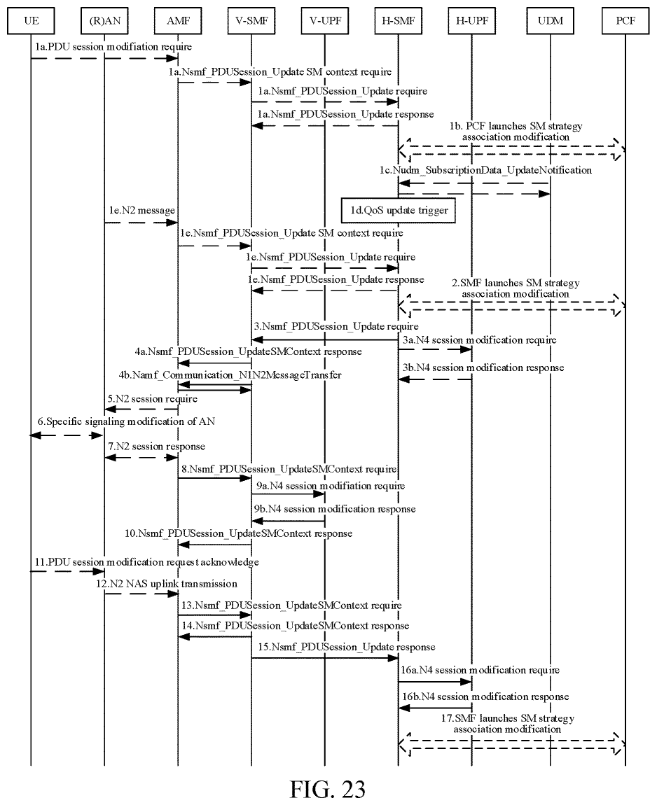

FIG. 23 illustrates a schematic diagram of a PDU session modification process requested by UE or a network for home route roaming provided by an exemplary embodiment of this disclosure.

The control parameters (namely each possible service flow, SDF and QoS flow) of one or more QNCs are added in step 1b, step 3, step 4b and step 5 of FIG. 23.

Step 3 of FIG. 23 is a new step relative to the scene described in FIG. 21, that is, the control parameters of the QNC are added on the QoS parameters of one of more QoS flows.

### 3. A QoS Notification in a Handover Process

3.1 A handover Scene of an Xn Interface:

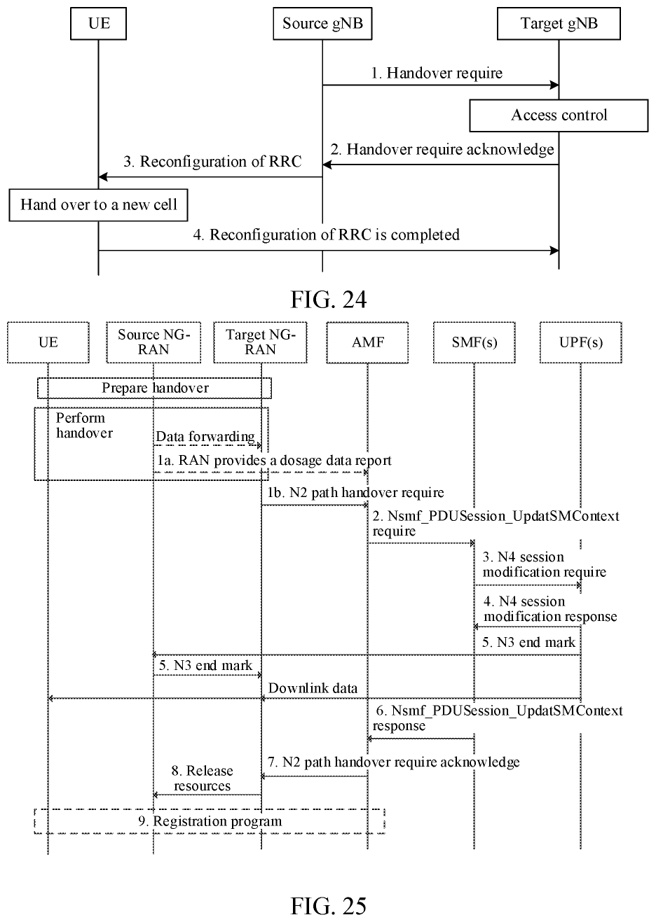

FIG. 24 illustrates a schematic diagram of a handover program in a base station provided by an exemplary embodiment of this disclosure. FIG. 25 illustrates a schematic diagram of an Xn-based inter NG-RAN handover process without UPF reallocation provided by this disclosure.

The control parameters of the QNC of the non-GBR bearing flow are added in step 1 of FIG. 24. Since there may be a plurality of QoS flows in the same UE, for any QoS flow in which the control parameters of the QNC exist in a source gNB, the control parameters of the QNC need to be provided to a target gNB.

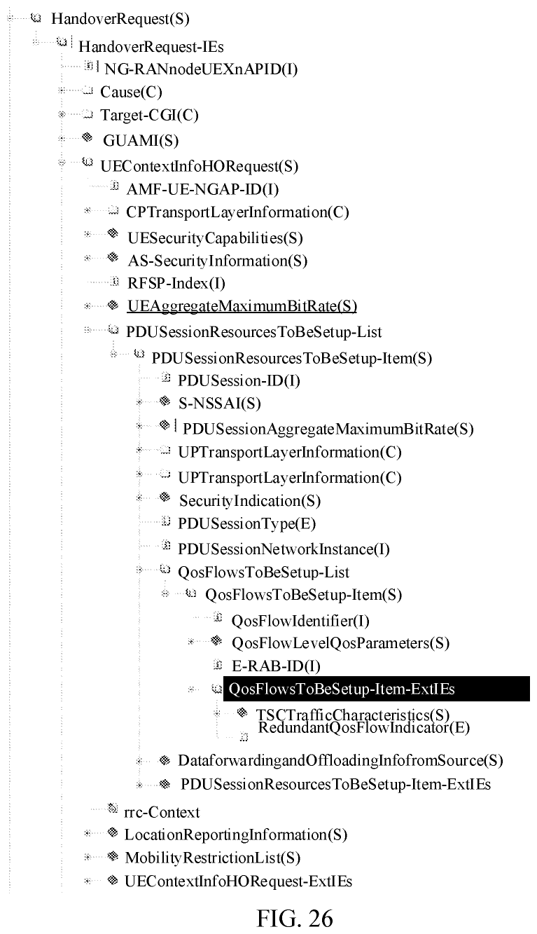

The first parameter value is carried in a handover request, such as a QoSFlowsToBeSetup-Item field shown in FIG. 26.

In addition, in order to support the subsequent QNC notification process, the source gNB further needs to report the parameter value, namely the first parameter value, corresponding to each parameter of the QNC on the current source side. In this way, after the UE successfully hands over to the target gNB, the resource state of the target gNB may be much better or worse than the resource state of the source-side gNB. After the UE successfully hands over to the target gNB, the target gNB may determine whether to report the notification message.

### 3.2 A Handover Preparation Scene Based on an XG-RAN Node N2:

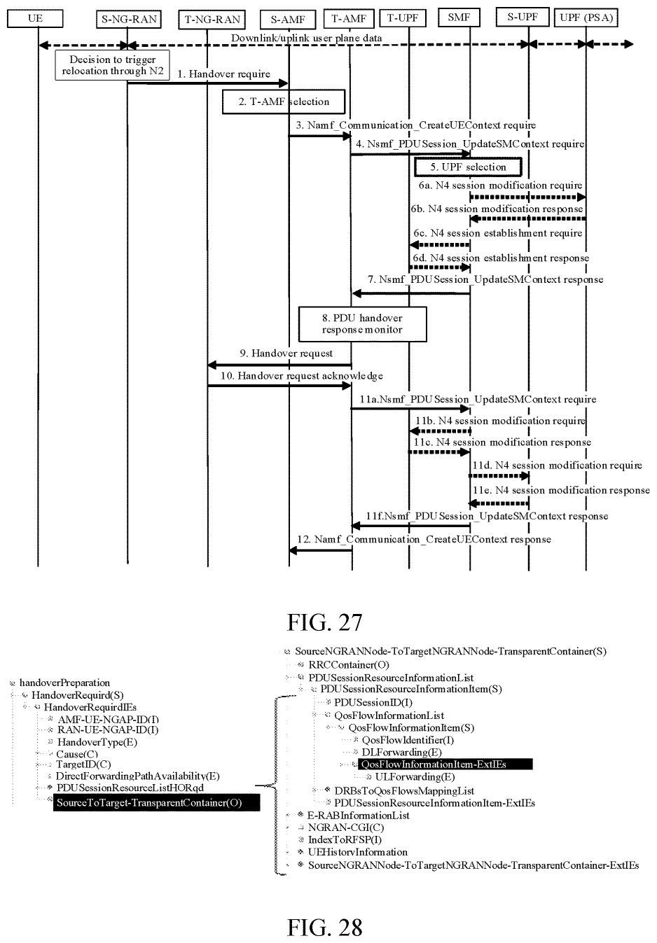

The control parameters of the QNC are added in steps 1, 3, 4, 7 and 9 of FIG. 27.

Exemplarily, the control parameters of the QNC are added in the handover request of step 1; and the control parameters of the QNC are added in the handover request of step 9.

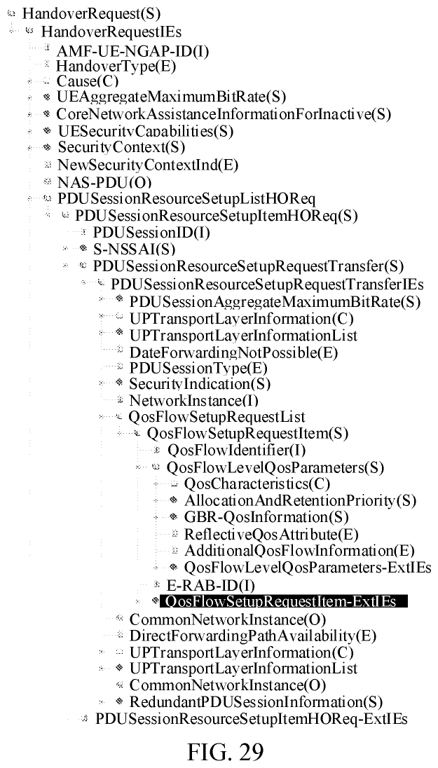

FIG. 28 illustrates a message structural diagram of a source-to-end transparent transmission container in a handover request, and the first parameter value is carried in the source-to-end transparent transmission container. FIG. 29 illustrates a QoSFlowSetupRequestItem field in a handover request, and the control parameter of the QNC may be carried in the request field.

Since there are a plurality of QFs, it needs to be provided for any QoS flow in which the control parameters of the QNC exist in the source gNB. In fact, this process just transmits the control parameters of the QNC of all QoS flows on the source NG-RAN to the target NG-RAN through a plurality of steps.

Similarly, in order to support the subsequent QNC notification process, the source gNB further needs to report each value, namely the first parameter value, corresponding to parameter of the QNC on the current source side. In this way, after the UE successfully hands over to the target gNB, the resource state of the target gNB will be much better or worse than the resource state of the source-side gNB. After the UE successfully hands over to the target gNB, the target gNB may determine whether to report the notification message. Therefore, the current values of the parameters of the QNC of all QoS flows on the source NG-RAN are added in steps 1, 3, 4, 7 and 9 in left figure.

A Scene of Handover From a non-3GPP to a 3GPP:

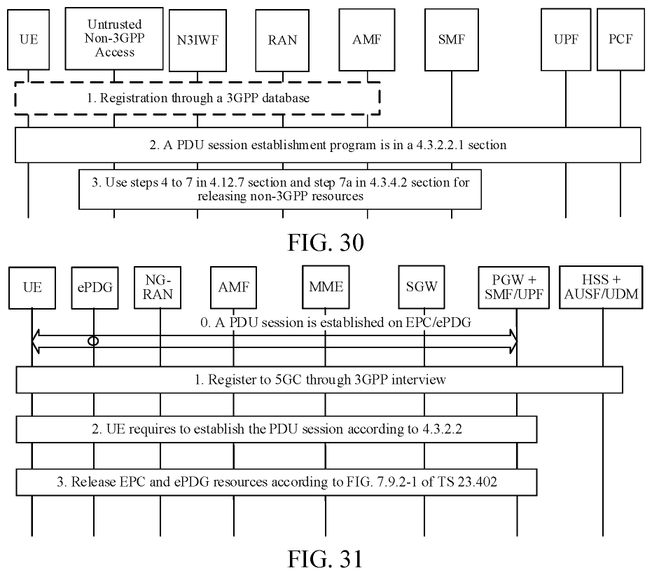

FIG. 30 illustrates a schematic diagram of a handover process (non roaming and local breakout roaming) of a PDU session process accessed from an untrusted non-3GPP to a 3GPP. FIG. 31 illustrates a schematic handover diagram of handing over from EPC/ePDG to 5GS.

It can be seen from FIG. 30 that the handover from 5G non-3GPP to 5GS or from 4G non-3GPP to 5GS uses a PDU session establishment process, and the process is defined in the above embodiments. Therefore, the QNC processing in the non-3GPP to 3GPP handover process may be implemented only be reusing the above embodiments.

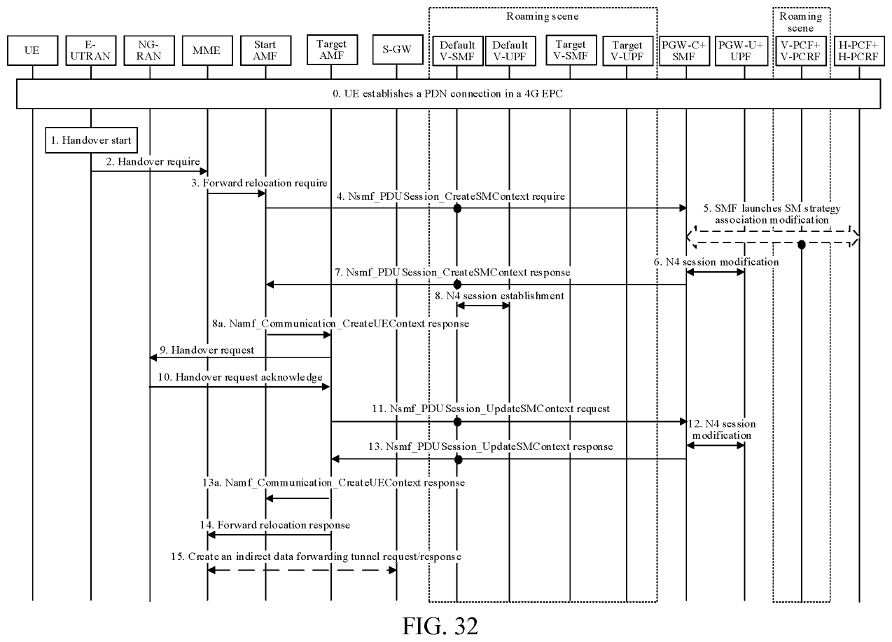

FIG. 32 illustrates a preparation stage of interworking based on single registration from EPS to 5GS. The processing mode of the embodiment is similar to FIG. 27, steps 2 and 3 only need to be modified to the response messages in a 5G system, that is, when handing over from 4G to 5GS, if 4G also supports the QNC, the 4G protocol needs to be updated.

The technology proposed by the embodiments of this disclosure may be applied to a 4G system. When applied to the 4G system, NR-gNB is replaced by eNB. The interaction between the PCF and the AF does not make any changes. The interaction between the SMF and the PCF is modified to the interaction between the PGW and the PCF. The QoS flow of 5G is replaced by the EPS bearer of 4G. 5QI of 5G is replaced by 4G QCI. The interaction between the RAN and the AMF/SMF in 5G is replaced by the interaction between the RAN and MME of 4G.

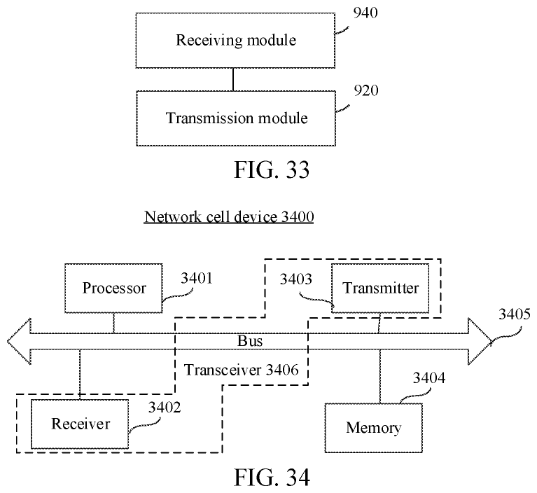

FIG. 33 illustrates a block diagram of an apparatus for notifying a QoS change provided by an exemplary embodiment of this disclosure. The apparatus may be implemented as a part of an access network device. The apparatus includes:
a transmitting module 920, configured to transmit, when a change of a parameter of QNC of a non-GBR bearing flow satisfies a reporting condition, a notification message to an application entity through a core network entity, so as to control, by the application entity, an application program according to the notification message.

In a possible design of this embodiment of this disclosure, the parameter of the QNC includes at least one of the following:
PDB; PER; and CBR.

In a possible design of this embodiment of this disclosure, the parameter of the QNC includes at least two kinds;
at least two reporting conditions corresponding to the parameter are the same; and/or at least two reporting conditions corresponding to the parameter are different.

In a possible design of this embodiment of this disclosure, the reporting condition includes at least one of the following:
a change value of the parameter of the QNC within a first duration is greater than a first threshold;
a change rate of the parameter of the QNC within a second duration is greater than a second threshold;
the change value of the parameter of the QNC within the first duration is greater than the first threshold, and a third threshold is continuously maintained; and
the change rate of the parameter of the QNC within the second duration is greater than the second threshold, and a fourth threshold is continuously maintained.

The third threshold and the fourth threshold are thresholds for measuring the duration.

In a possible design of this embodiment of this disclosure, the notification message includes:
a parameter value of changed QNC; or
a quantized value of the parameter value of the changed QNC.

In a possible design of this embodiment of this disclosure, the non-GBR bearing flow includes:
a non-GBR QoS flow; or a non-GBR EPS bearer.

In a possible design of this embodiment of this disclosure,
the QNC is defined in an uplink; or the QNC is defined in a downlink; or the QNC is defined in the uplink and the downlink.

In a possible design of this embodiment of this disclosure, there is a one-to-one correspondence between the non-GBR bearing flow and a target service flow, and the target service flow is a service flow including the QNC and the parameter of the QNC.

In a possible design of this embodiment of this disclosure, the transmitting module 920 is configured to transmit the notification message to the core network entity, so as to transmit, by the core network entity, the notification message to the application entity.

In a possible design of this embodiment of this disclosure, the core network entity includes a first core network entity and a second core network entity; and
the transmitting module 920 is configured to transmit the notification message to the first core network entity, so as to forward, by the first core network entity, the notification message to the second core network entity.

In a possible design of this embodiment of this disclosure, the apparatus further includes:
a receiving module 940, configured to receive a QNC profile transmitted by the core network entity, the QNC profile including the parameter of the QNC of the non-GBR bearing flow and the reporting condition.

In a possible design of this embodiment of this disclosure, the receiving module 940 is configured to receive an N2 PDU session request transmitted by the core network entity, the N2 PDU session request carrying the QNC profile.

FIG. 34 illustrates a schematic structural diagram of a network cell device provided by an exemplary embodiment of this disclosure. For example, the network cell device may be configured to perform the control method of the above application program. Specifically speaking, the network cell device 3400 may include: a processor 3401 (including processing circuitry), a receiver 3402, a transmitter 3403, a memory 3404 (including a non-transitory computer-readable storage medium), and a bus 3405.

The processor 3401 includes one or more processing cores. The processor 3401 runs a software program and a module to execute various functional applications and perform information processing.

The receiver 3402 and the transmitter 3403 may be implemented as a transceiver 3406, and the transceiver 3406 may be communication chip.

The memory 3404 is connected to the processor 3401 through the bus 3405.

The memory 3404 may be configured to store a computer program, and the processor 3401 is configured to perform the computer program, so as to implement various steps performed by the network cell device, the access network device, a core network cell or the core network entity in the above method embodiments.

The transmitter 3403 is configured to perform the steps related to transmitting in the above embodiments; the receiver 3402 is configured to perform the steps related to receiving in the above embodiments; and the processor 3401 is configured to perform other steps except transmitting and receiving in the above embodiments.

In addition, the memory 3404 may be implemented by using any type of volatile or non-volatile storage device or a combination thereof. The volatile or non-volatile storage device includes, but is not limited to: a random-access memory (RAM), a read-only memory (ROM), an erasable programmable ROM (EPROM), an electrically erasable programmable ROM (EEPROM), a flash memory or another solid-state memory technology, a compact disc read-only memory (CD-ROM), a digital versatile disc (DVD), or another optical memory, a tape cartridge, a magnetic cassette, a magnetic disk memory, or another magnetic storage device.

In an exemplary embodiment, a network element device is further provided, and the network element device includes: a processor and a memory, the memory storing a computer program, the computer program being loaded and executed by the processor to implement the method for notifying a QoS change. In an embodiment, the network cell device is the access network device.

This disclosure further provides a computer-readable storage medium, the storage medium storing at least one instruction, at least one program, a code set, or an instruction set, and the at least one instruction, the at least one program, the code set, or the instruction set being loaded and executed by a processor to implement the method for notifying a QoS change according to the foregoing method embodiments.

In an embodiment, a computer program product is further provided in this disclosure, the computer program product including computer instructions, the computer instructions being stored in a computer-readable storage medium. A processor of a computer device reads the computer instructions from the computer-readable storage medium and executes the computer instructions to cause the computer device to perform the method for notifying a QoS change according to the foregoing method embodiments.

The foregoing disclosure includes some exemplary embodiments of this disclosure which are not intended to limit the scope of this disclosure. Other embodiments shall also fall within the scope of this disclosure.

What is claimed is:

1. A method for notifying a quality of service (QoS) change, the method comprising:
transmitting, by an access network device, a notification message to an application entity when a change of a parameter of QoS notification control (QNC) of a non-guaranteed bit rate (non-GBR) bearing flow in a mobile network meets a reporting condition, the application entity being configured to perform an application function (AF) through a core network entity;
receiving, by the access network device, an updated reporting condition of the QNC that is determined and transmitted by the application entity to the access network device through the core network entity when the application entity determines that a reporting frequency of the notification message is greater or less than a frequency threshold, the updated reporting condition of the QNC including an adjustment to the reporting condition of the change of the parameter of the QNC; and
adjusting, by the access network device, the reporting frequency of the notification message transmitted by the access network device to the application entity based on the updated reporting condition.

2. The method of claim 1, wherein:
the core network entity includes at least one of a session management function (SMF) or a policy control function (PCF), and
the access network device is a radio access network (RAN) in the mobile network.

3. The method according to claim 1, wherein the parameter of the QNC comprises at least one of:
a packet delay budget (PDB);
a packet error rate (PER); or
a current bit rate (CBR).

4. The method according to claim 3, wherein
the parameter of the QNC comprises at least two of the PDB, the PER, and the CBR; and
the reporting condition includes at least two reporting conditions corresponding to the at least two of the PDB, the PER, and the CBR, where the at least two reporting conditions are the same, or the at least two reporting conditions are different.

5. The method according to claim 1, wherein the reporting condition comprises at least one of:
a value change of the parameter of the QNC within a first duration is greater than a first threshold;
a change rate of the parameter of the QNC within a second duration is greater than a second threshold;
the value change of the parameter of the QNC within the first duration is greater than the first threshold, and the value change of the parameter of the QNC is maintained over a third time duration continuously; or
the change rate of the parameter of the QNC within the second duration is greater than the second threshold, and the change rate of the parameter of the QNC is maintained over a fourth time duration continuously.

6. The method according to claim 1, wherein the notification message comprises:
a value of the change of the parameter of the QNC; or
a quantized value corresponding to the value of the change of the parameter of the QNC.

7. The method according to claim 1, wherein the non-GBR bearing flow comprises:
a non-GBR QoS flow; or
a non-GBR evolved packet system (EPS) bearer.

8. The method according to claim 1, wherein
the QNC is defined in an uplink; or
the QNC is defined in a downlink; or
the QNC is defined in the uplink and the downlink.

9. The method according to claim 1, wherein
there is a one-to-one correspondence between the non-GBR bearing flow and a target service flow, and the target service flow is a service flow comprising the QNC and the parameter of the QNC.

10. The method according to claim 1, wherein the transmitting comprises:
transmitting the notification message to the core network entity, so as to cause the core network entity to transmit the notification message to the application entity.

11. The method according to claim 10, wherein
the core network entity comprises a first core network entity and a second core network entity; and
the transmitting the notification message to the core network entity comprises:
transmitting the notification message to the first core network entity, so as to forward, by the first core network entity, the notification message to the second core network entity.

12. The method according to claim 1, the method further comprising:
receiving, by the access network device, a QNC profile transmitted by the core network entity, the QNC profile comprising the parameter of the QNC of the non-GBR bearing flow and the reporting condition.

13. The method according to claim 12, wherein the receiving comprises:
receiving, by the access network device, an N2 interface protocol data unit (PDU) session request transmitted by the core network entity, and the N2 interface PDU session request carrying the QNC profile.

14. An apparatus of a radio access network (RAN) for notifying a quality of service (QoS) change, the apparatus comprising:
processing circuitry configured to
transmit a notification message to an application entity when a change of a parameter of QoS notification control (QNC) of a non-guaranteed bit rate (non-GBR) bearing flow in a mobile network meets a reporting condition, the application entity being configured to perform an application function (AF) through a core network entity;
receive an updated reporting condition of the QNC that is determined and transmitted by the application entity to the RAN through the core network entity when the application entity determines that a reporting frequency of the notification message is greater or less than a frequency threshold, the updated reporting condition of the QNC including an adjustment to the reporting condition of the change of the parameter of the QNC; and
adjust the reporting frequency of the notification message transmitted by the apparatus to the application entity based on the updated reporting condition.

15. The apparatus according to claim 14, wherein the parameter of the QNC comprises at least one of:
a packet delay budget (PDB);
a packet error rate (PER); or
a current bit rate (CBR).

16. The apparatus according to claim 15, wherein
the parameter of the QNC comprises at least two of the PDB, the PER, and the CBR; and
the reporting condition includes at least two reporting conditions corresponding to the at least two of the PDB, the PER, and the CBR, where the at least two reporting conditions are the same, or the at least two reporting conditions are different.

17. The apparatus according to claim 14, wherein the reporting condition comprises at least one of:
a value change of the parameter of the QNC within a first duration is greater than a first threshold;
a change rate of the parameter of the QNC within a second duration is greater than a second threshold;
the value change of the parameter of the QNC within the first duration is greater than the first threshold, and the value change of the parameter of the QNC is maintained over a third time duration continuously; and
the change rate of the parameter of the QNC within the second duration is greater than the second threshold, and the change rate of the parameter of the QNC is maintained over a fourth time duration continuously.

18. The apparatus according to claim 14, wherein the notification message comprises:
a value of the change of the parameter of the QNC; or
a quantized value corresponding to the value of the change of the parameter of the QNC.

19. The apparatus according to claim 14, wherein the non-GBR bearing flow comprises:
a non-GBR QoS flow; or
a non-GBR evolved packet system EPS bearer.

20. A non-transitory computer-readable storage medium storing computer-readable instructions thereon, which, when executed by processing circuitry of a radio access network (RAN), cause the processing circuitry to perform a method for notifying a quality of service (QoS) change, the method comprising:
transmitting, by the processing circuitry of the RAN, a notification message to an application entity when a change of a parameter of QoS notification control (QNC) of a non-guaranteed bit rate (non-GBR) bearing flow in a mobile network meets a reporting condition, the application entity being configured to perform an application function (AF) through a core network entity;
receiving, by the processing circuitry of the RAN, an updated reporting condition of the QNC transmitted by the application entity to the RAN through the core network entity when the application entity determines that a reporting frequency of the notification message is greater or less than a frequency threshold, the updated reporting condition of the QNC including an adjustment to the reporting condition of the change of the parameter of the QNC; and
adjusting, by the processing circuitry of the RAN, the reporting frequency of the notification message transmitted by the processing circuitry of the RAN to the application entity based on the updated reporting condition.
